(19) United States
(12) Patent Application Publication
(10) Pub. No.: US 2012/0179502 A1
(43) Pub. Date: Jul. 12, 2012

(54) METHOD FOR COORDINATING RESOURCES FOR EVENTS AND SYSTEM EMPLOYING SAME

(75) Inventors: Umar Farooq, Calgary (CA); Shymmon Banerjee, Calgary (CA); Andy Leung, Calgary (CA); Alex Alexeev, Calgary (CA); Sean Bacchus, Calgary (CA); Alexander Garin, Calgary (CA); Tom Willekes, Calgary (CA); Douglas Blair Hill, Calgary (CA); Jeff Lewis, Calgary (CA)

(73) Assignee: SMART TECHNOLOGIES ULC, Calgary (CA)

(21) Appl. No.: 13/348,490

(22) Filed: Jan. 11, 2012

Related U.S. Application Data
(60) Provisional application No. 61/431,828, filed on Jan. 11, 2011.

(51) Int. Cl. G06Q 10/06

(52) U.S. Cl. 705/7.13

(57) ABSTRACT

A method for coordinating resources for events, the method comprises identifying participants for an event; collecting information concerning the identified participants, the information at least comprising availability schedules; and providing an event monitoring interface to at least one participant device, the event monitoring interface presenting a representation of identified participants and at least one resource associated with the event.

### CROSS-REFERENCE TO RELATED APPLICATIONS

This application claims the benefit of U.S. Provisional Application No. 61/431,828 to Farooq et al. filed on Jan. 11, 2011, entitled “METHOD FOR COORDINATING RESOURCES FOR EVENTS AND SYSTEM EMPLOYING SAME”, the content of which is incorporated herein by reference in its entirety.

### FIELD OF THE INVENTION

The present invention relates generally to event coordination, and in particular to a method for coordinating resources for events and a system employing same.

### BACKGROUND OF THE INVENTION

Events within organizations are often scheduled based on the availability of event participants and the availability of resources required to run the events. In the case where the event is a meeting, these resources may include, for example, meeting rooms, and meeting equipment, such as projectors and video equipment. Depending on the size of the organization and the availability of resources, scheduling and managing an event can be challenging.

Event scheduling and management software products to facilitate the scheduling and management of events are known. For example, Microsoft® Outlook® Calendar, EmergingSoft MeetingPlanner™, NetSimplicity Meeting Room Manager™, CyberMatrix® Meeting Manager™, OfficeTracker™, and Microsoft® Live Meeting are commercially available software products that provide event scheduling functions. Several of these software products also enable viewing of the usage schedules of organization resources, such as employees, meeting rooms, and meeting room equipment. Users can use these software products to view the schedules of prospective event participants and other resources so as to determine one or more suitable time slots during which the resources required for the event are available. The software products can then be used to schedule the event during a suitable time slot by notifying the participants and reserving the resources.

Other software products may be used to facilitate the process of determining suitable time slots for scheduling an event. For example, Microsoft® Outlook® 2007 allows a user to invoke a Meeting Assistant that browses time slots of a calendar, identifies participants and other resources that are available during each of the time slots, and reports to the user suitable time slots in order of earliest availability. The user can then select a time slot for the event.

Other software applications may be used to facilitate negotiation between users about a scheduled event time. For example, negotiation may be done via email or by voting on a website. Meeting Wizard, Meetomatic, AgreeADate, Doodle, Pointment and TimeToMeet are examples of such web-based services.

Still other approaches are known. For example, U.S. Patent Application Publication No. 2008/0109517 to Sarkar et al. discloses a method comprising sending an electronic invitation to an endpoint associated with a user. The electronic invitation requests that the user attend a conference session to be held at a specified time over a network. A set of filtering rules is then applied to the electronic invitation to select a delegate to attend the conference session in place of the user. Once a delegate has been selected, the electronic invitation is forwarded to the delegate.

U.S. Patent Application Publication No. 2009/0006608 to Gupta et al. discloses a system in which meeting attendees have resources available to participate in an efficient meeting regardless of where the attendees are located. Information can be gathered that relates to the attendees, the subject matter of the meeting or other information. In addition, relationships between attendees, if any, can be determined and displayed to the attendees to show the interrelatedness of the group. Various aspects during the meeting can also be observed and analyzed to allow the attendees to become more aware of the dynamics between individuals as well as the entire team.

U.S. Patent Application Publication No. 2009/0232291 to Pranhune et al. discloses a method comprising receiving at a local conference coordinator a first indication of a scheduled conference that includes a plurality of conference details. The method also includes transmitting at least one of the plurality of conference details to a remote conference coordinator and receiving at least one additional conference detail regarding the scheduled conference from the remote conference coordinator. The method additionally includes determining conference scheduling information comprising at least one resource to be used for the scheduled conference based on the plurality of conference details and the at least one additional conference detail. The method also includes identifying a conference room supporting the at least one resource to be used for the scheduled conference. The method further includes transmitting conference scheduling information to the conference room such that an interface in the conference room can initiate the scheduled conference based on a single indication received from a user.

U.S. Pat. No. 7,260,771 to Chiu et al. discloses a method for creating multimedia meeting minutes. Notations are received from a user, and as each notation is received, context information is recorded with the notation. The context information is used to select pertinent portions of multimedia information received concurrently with the notations. An association is then created between the notation and each selected portion of the multimedia information. These associations may be used to access the selected portions of the multimedia information from the notations. The notations and their respective associations are deposited for future retrieval. The deposited notations may be revised by receiving an altered copy of the notations from a user. The deposited notations are modified in accordance with the altered copy.

U.S. Pat. No. 7,599,996 to Gupta et al. discloses a facility that allows for automatic delegation of incoming real-time communications based on a delegation scheme. The delegation scheme may be rules-based and may be applied to a single real-time communication channel or multiple communication channels, including both real-time and non-real-time communication channels. Delegate information may include rules that indicate under what circumstances a communication should be rerouted, which delegate the communication should be rerouted to, and whether other associated actions should be taken in connection with the rerouting (or lack thereof). In some cases, the context of the incoming communication may play a role in how or whether a communication is rerouted to a delegate.

Although known event scheduling and management software products may be useful, improvements are desirable. For example, some software products may not adapt well to changes in availability of participants and/or event resources. Such changes in resource availability may include changes in location, operability, or scheduling, for example. As will be appreciated, such changes in the availability of participants and/or event resources may occur frequently in a busy organization. Additionally, there may also be a need to organize event resources on a last-minute or ad hoc basis, so as enable participants to meet about an unexpected or emergency issue, for example. Furthermore, some participants may maintain ever-changing workplace schedules, and may for example travel between different sites of the organization on a frequent basis. Additionally, the event resources may be generally scarce, and competition for these resources may exist within the organization.

Under these conditions, it may be challenging for an event planner to schedule and manage an event using known meeting scheduling and management software products. For example, prior art software products may not be configured to receive dynamic updates of resource availability. This may require an event planner to manually coordinate the event resources for another suitable time. Where dynamic updates are available, known event scheduling and management software products may lack an ability to integrate resource availability information provided by multiple information sources. Known event scheduling and management software products may also only provide limited capability of adapting to participant preferences and participant schedules. For example, users may be required to re-enter the same settings each time an event is scheduled.

Managing an event may be complicated when the event involves a plurality of participants, event rooms and other event resources that are physically located in different sites of the organization. For example, prior to starting an event, an event host may need to prepare the event room and to establish data, audio and/or video bridges through which remote participants outside the event room may attend the event. In cases where event participants are required to have common access to one or more data files, locating and attaching these files to the event may be burdensome.

Additionally, known event scheduling and management software products may not be capable of fully adapting to changes in organization policy, such as, for example, a change to a “no meetings during lunchhour” policy. Additionally, known software products may also not be capable of fully adapting to changes in organization structure, such as for example the number of departments within the organization, or the management structure. Such changes may require an administrator to manually update settings configurations within a known software product to reflect these changes. In some cases, the administrator may be required to install a software upgrade so as to accommodate the changes.

It is therefore an object of the present invention to provide a novel method for coordinating resources for events and a system employing same.

### SUMMARY OF THE INVENTION

According to one aspect there is provided a method for coordinating resources for events, the method comprising identifying participants for an event; collecting information concerning the identified participants, the information at least comprising availability schedules; and providing an event monitoring interface to at least one participant device, the event monitoring interface presenting a representation of identified participants and at least one resource associated with the event.

In one embodiment, the method further comprises determining resources to be used for the event according to locations of the participants. In a related embodiment, the method further comprises setting up at least one of a video bridge, an audio bridge, and a data bridge between at least one of the participants and a server.

In another embodiment, the representation visually distinguishes participants that have joined the event from participants that have not joined the event as well as visually distinguishes resources that have joined the event from resources that have not joined the event.

In another embodiment, the method further comprises scheduling the event based on the collected information; and starting the event according to the scheduling. The collecting may comprise collecting the information from any of an employee database, an e-mail server, a projects server, a file server, and sensors.

In another embodiment, the method further comprises recording event content in an event log. In a related embodiment, the event content comprises any of audio data, video data, event notes, event minutes, and documents.

In another embodiment, the event monitoring interface is provided to each participant device after said starting step, and after the at least one participant has logged in to the event. In a related embodiment, providing the event monitoring interface further comprises providing an event map.

In another embodiment, the method further comprises terminating the event, and generating event minutes.

In another embodiment, the method further comprises starting the event in response to an ad hoc event request.

In another aspect, there is provided a system for coordinating resources for events, the system comprising a network; and processing structure in communication with the network, the processing structure being configured to select participants for an event; collect information concerning the selected participants, the information comprising availability schedules; and provide an event monitoring interface to at least one participant device, the event monitoring interface presenting a representation of identified participants and at least one resource associated with the event.

In yet another aspect, there is provided a method comprising initiating an event by identifying participants; directing collection of information relating to the identified participants; and directing the presentation of an event monitoring interface for providing a representation of participants and at least one resource associated with the event.

In still yet another aspect, there is provided a method comprising receiving a request to join an event; and upon joining the event in response to said request, receiving instructions for displaying an event monitoring interface, the event monitoring interface providing a representation of participants and at least one resource associated with the event.

In yet another aspect there is provided a server configured to coordinate resources for events, the server being configured to identify participants for an event; collect information concerning the identified participants, the information at least comprising availability schedules; and cause a representation of identified participants and at least one resource associated with the event to be presented by at least one participant device.

In still yet another aspect there is provided an apparatus comprising processing structure; and memory in communication with the processing structure, the memory having embodied thereon computer-readable code which, when executed by the processing structure, directs the apparatus to establish communication with a remotely hosted event during which information concerning identified event participants is collected, the information at least comprising availability schedules; and display an event monitoring interface, the event monitoring interface presenting a representation of identified participants and at least one resource associated with the event.

In yet another aspect there is provided a non-transitory computer-readable medium having embodied thereon a computer program for coordinate resources for events, the computer program comprising computer-readable code which, when executed by processing structure, carry out identifying participants for an event; collecting information concerning the identified participants, the information at least comprising availability schedules; and providing an event monitoring interface to at least one participant device, the event monitoring interface presenting a representation of identified participants and at least one resource associated with the event.

### BRIEF DESCRIPTION OF THE DRAWINGS

Embodiments will now be described more fully with reference to the accompanying drawings in which:

FIG. 1 is a schematic view of a system for coordinating resources for events in an organization.

FIG. 2 is a block diagram of software architecture used by the system of FIG. 1.

FIG. 3 is a schematic diagram of an event manager forming part of the system of FIG. 1.

FIG. 4 is a block diagram of event services provided by the system of FIG. 1.

FIGS. 5A and 5B are Event List and Event Notification windows, respectively, presented by the system of FIG. 1.

FIG. 6 is a block diagram of an event recording service provided by the system of FIG. 1.

FIG. 7 is a schematic diagram of exemplary event content recorded by the event recording service of FIG. 6.

FIG. 8 is a flowchart showing steps of an event management process used by the system of FIG. 1.

FIG. 9 is an Event Scheduler window presented by the system of FIG. 1.

FIG. 10 is an Attach Projects window presented by the system of FIG. 1.

FIGS. 11A and 11B are flowcharts showing steps of an event server-side event start process and an event client-side event start process, respectively, used by the system of FIG. 1.

FIG. 12 is an event Dashboard window presented by the system of FIG. 1.

FIG. 13 is a Participant Information window presented by the system of FIG. 1.

FIG. 14 is an Event Room Information window presented by the system of FIG. 1.

FIG. 15 is an Agenda Item Assignment window presented by the system of FIG. 1.

FIG. 16 is a Comment Board window presented by the system of FIG. 1.

FIG. 17 is an Event Map window presented by the system of FIG. 1.

FIG. 18 is the Event Map window of FIG. 17, having been updated after additional event participants have joined.

FIG. 19 is the Event Map window of FIG. 18, having been updated after a computer has begun sharing data.

FIG. 20 is the Event Map window of FIG. 19, showing a participant list.

FIG. 21 is the Event Map window of FIG. 19, showing a comment received by an event participant.

FIG. 22 is the Event Map window of FIG. 19, showing a vote request received by an event participant.

FIGS. 23A to 23C are flowcharts showing steps in an Event Map generation process, an Event Map node drawing process, and an Event Map connection drawing process, respectively, used by the system of FIG. 1.

FIG. 24 is a flowchart showing steps in an end-event process used by the system of FIG. 1.

FIG. 25 is a Recorded Event Information window presented by the system of FIG. 1.

FIG. 26 is an Ad Hoc Event Start window presented by the system of FIG. 1.

FIG. 27 is the Event Map window of FIG. 17, showing an ad hoc event.

FIG. 28 is the Event Map window of FIG. 27, having been updated after an additional event participant has joined.

FIG. 29 is the Event Map window of FIG. 28, having been updated after a further additional event participant has joined.

FIG. 30 is a Microsoft® Office Communicator window comprising an event management plugin, presented by the system of FIG. 1.

### DETAILED DESCRIPTION OF THE EMBODIMENTS

In the following, a method for coordinating resources for events and a system employing same are described. The method generally comprises collecting information from a variety of sources, and providing a variety of functions for facilitating the management of resources during an event. These functions may be, for example, event quick start, automatic event resource reservation, and event recording. The system employing the method may comprise a variety of hardware devices, such as for example interactive whiteboards, computing devices, such as desktop computers, laptop computers, tablet computers, notebook computers, smartphones and personal digital assistants (PDAs), sensors, servers comprising various databases (LDAP, project, file, etc.) etc. Some of the functions are integrated into the hardware devices, while other functions are generally implemented as software applications to facilitate system configuration. In embodiments described hereafter, the events are meetings to be held within an organization for example a business entity, such as a corporation. However, as will be understood, the method and system employing the same may alternatively be applied to other events within other organizations.

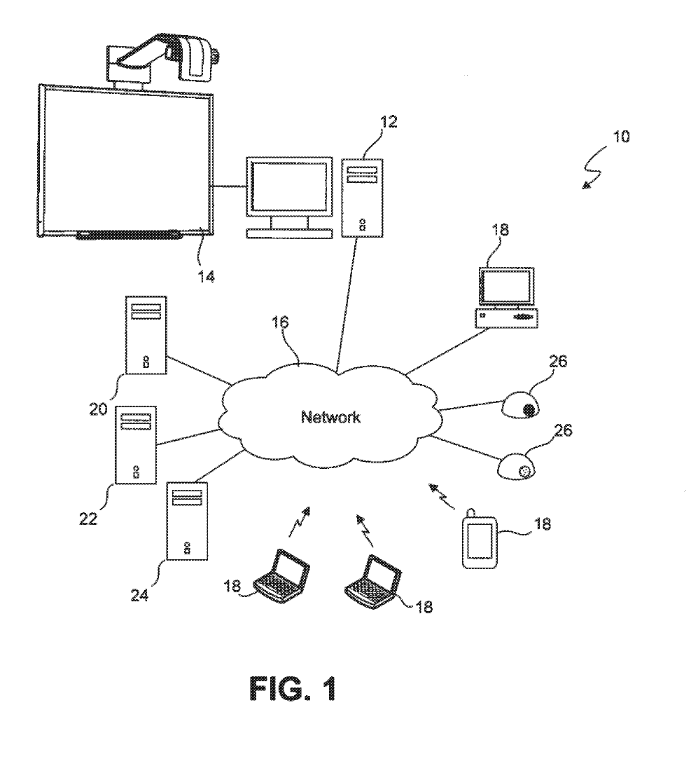

Turning now to FIG. 1, system for coordinating resources for events in an organization is shown, and is generally identified by reference numeral 10. System 10 comprises a general purpose computing device 12 which, in this embodiment, is physically located in an event room. The general purpose computing device 12 in this embodiment is a personal computer or other suitable processing device comprising, for example, a processing unit, system memory (volatile and/or non-volatile memory), other non-removable or removable memory (e.g. a hard disk drive, RAM, ROM, EEPROM, CD-ROM, DVD, flash memory, etc.) and a system bus coupling the various computer components to the processing unit.

General purpose computing device 12 is in communication with a network 16 over either a wired or wireless connection. In this embodiment, the network is an intranet within the organization; however the network 16 may alternatively be another network, such as for example a local area network (LAN) within the organization, a cellular network, the Internet, or a combination of different networks. In this embodiment, the general purpose computing device 12 is connected, via the network 16, to one or more servers such as for example an event server 20, an audio, video and data conferencing server 22 and one or more other servers 24. The other servers may comprise, for example, a Microsoft® Exchange server, an employee database server, a project server, and the like. Event server 20 manages events and event resources. The audio, video and data conferencing server 22 receives and synthesizes any audio, video and data streams, respectively, from event participants during an event, and broadcasts the synthesized streams to participants of the event. The audio, video and data conferencing server 22 establishes a session (or “bridge”) for each of the streams used during the event. In this embodiment, the audio, video and data conferencing server 22 comprises two servers, namely a SMART Bridgit™ server offered by SMART Technologies ULC of Calgary, Alberta, Canada for processing and handling video and data streams, and a Cisco MeetingPlace server for processing and handling audio streams.

System 10 also comprises an interactive whiteboard (IWB) 14 connected to the general purpose computing device 12. IWB 14 is configured to display event content via a user interface of an event management application and to receive touch input from event participants. System 10 also comprises at least one participant computing device 18 in communication with the general purpose computing device 12 via the network 16. In the example shown, four (4) participant computing devices 18 communicate with the general purpose computing device 12 over the network 16. Those of skill in the art will appreciate that this number of participant computing devices is exemplary only and that more or fewer participant computing devices 18 may be included in the system 10. The participant computing devices 18 may take a variety of forms including for example personal computers, laptop computers, notebook computers, tablet computers, computer servers, computerized kiosks, PDAs, cellular phones, smartphones etc. Each participant computing device 18 collaborates with the general purpose computing device 12 and with any other participant computing device 18 to process shared event data. The general purpose computing device 12 and the participant computing devices 18 are configured to share a common screen image, and the shared screen image may be modified by the participants. In this embodiment, the shared screen image is displayed on IWB 14 by general purpose computing device 12, allowing event participants who are located in the event room to modify the shared screen image through touch input with IWB 14. This touch input may take the form of digital ink input on the IWB 14, for example. Participants who are located outside of the event room may modify the shared screen image by using input devices associated with their respective participant computing device 18. The input devices may for example include any of computer mice, keyboards, touch screens, tablets, digital pens etc.

System 10 also comprises sensors 26 in the event room configured for detecting the presence of participants in the event room. In this embodiment, sensors 26 comprise a radio frequency identification (RFID) sensor and a video camera. Also, in this embodiment, the general purpose computing device 12 and one or more of the participant computing devices 18 are equipped with a respective camera for automatically capturing images of participants during use.

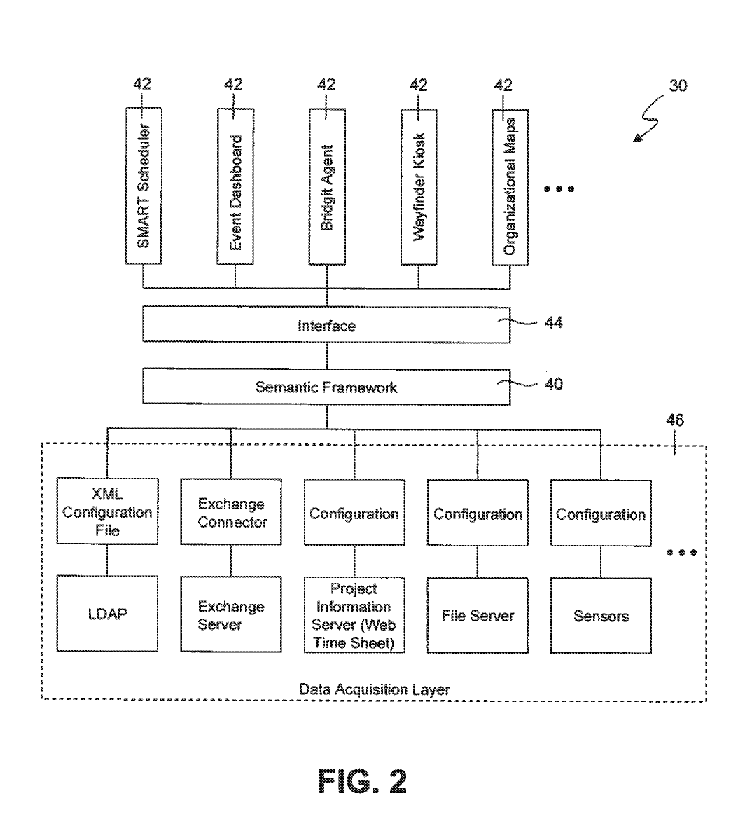

FIG. 2 is a block diagram of a software architecture of the system of FIG. 1, and which is generally indicated by reference numeral 30. Software architecture 30 comprises a semantic framework layer 40. Specifics of the semantic framework layer 40 are disclosed in International PCT Patent Application No. WO 2010/066023 assigned to SMART Technologies ULC, assignee of the subject application, the content of which is incorporated herein by reference in its entirety. Software architecture 30 also comprises a plurality of applications 42 in communication with the semantic framework layer 40 via a software interface/software development kit (SDK) 44. In the embodiment shown, the applications 42 comprise an Event Scheduler, an Event Dashboard, a Bridgit™ Agent, a Wayfinder Kiosk, and Organizational Maps. It will however be understood that other applications may alternatively be used. The applications 42 typically include both client-side applications and server-side applications. Some server-side applications comprise both a client-side component and a server-side component. In this case, the client-side components receive commands and queries relating to an event from participants, communicate with the server-side components to obtain results, such as for example, creation of an event, a change of an event, and information about an event, and then provides the results to the participants.

Software architecture 30 also comprises a data acquisition layer 46 in communication with the semantic framework layer 40. Data acquisition layer 46 is configured to collect information from a variety of sources. Depending on the configuration of the system 10, information is collected from any of databases, servers, software applications, and sensors.

Various kinds of information may be collected by the data acquisition layer 46. For example, the collected information may be user information collected from an employee database using Lightweight Directory Access Protocol (LDAP), and may for example comprise phone numbers, email addresses, and office locations. As another example, the collected information may be a list of meetings scheduled for a user, and collected from a Microsoft® Exchange Server and from the user's computerized address books and calendars. As still another example, the collected information may be meeting schedules collected from the Microsoft® Exchange Server. As still yet another example, the collected information may be a list of meeting room availabilities collected from a database within the organization using LDAP. As still another example, the collected information may be a description of a project. A project generally refers to a quantity of data relating to a single endeavour, where the quantity of data is organized under a single project name. The quantity of data may comprise any of, for example, files, documents, database queries, plans, schedules, assignments, and the like. The collected information describing the project may comprise any of the project name, a timesheet of the project, and project-related files obtained from a project database, a project file server or other file servers. As still another example, the collected information may be a meeting agenda obtained from any of an agenda server and a Microsoft® Exchange Server. As still yet another example, the collected information may be data conferencing information, such as the name of the SMART Bridgit™ conferencing server, the Bridgit™ meeting name and password, or a WebEx™ meeting name and password, all of which may be dynamically generated, and sent to event participants prior to the start of the event.

The semantic framework 40 is configured to organize the information collected by data acquisition layer 46 into one or more ontologies, and to store relevant rules, as described in the above-incorporated International PCT Patent Application No. WO 2010/066023. Semantic framework 40 is also configured to utilize machine learning algorithms to extract event-related information from unstructured sources such as, for example, emails, event agendas and event minutes. Based on the inter-relationships between ontologies, the semantic framework 40 is thereby configured to extract additional information from the collected information.

System 10 is functionally partitioned into an event manager and event clients. The event manager generally comprises the semantic framework 40 and the server-side applications 42, as well as any server-side application components of server-side applications 42. The event manager organizes information collected by the semantic framework 40 and provides an overview of all event-related information of the organization. The event clients generally comprise both the client-side applications 42 and the client-side components of server-side applications 42, any of which may be running on the general purpose computing device 12 and on the participant computing devices 18.

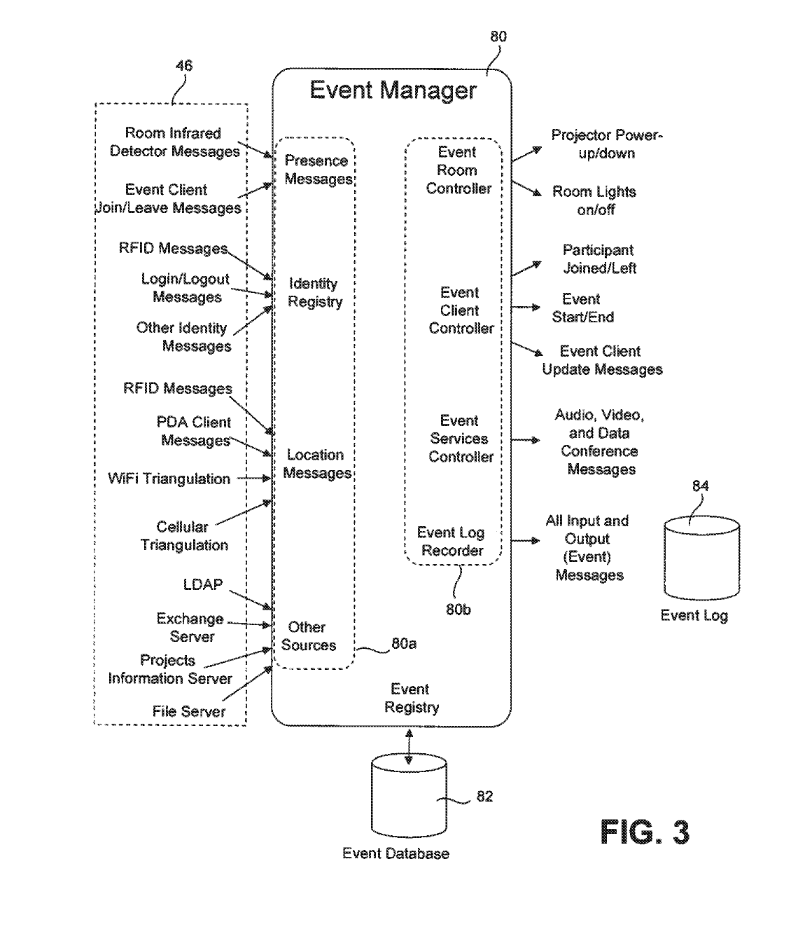

FIG. 3 shows the event manager, which is indicated generally by reference numeral 80. Event manager 80 comprises receivers 80a that are configured to receive information from the data acquisition layer 46 as input messages, and event controllers 80b that are configured to generate event control messages. In the embodiment shown, the input messages are grouped into categories, namely: presence messages, such as event room IR sensor messages and event client join/leave messages; identity registry messages, such as RFID messages, general purpose computing device user login/logout messages and other identity messages; location messages, such as RFID messages, PDA client messages, WiFi triangulation messages and cellular triangulation messages; and responses from the LDAP server, the Exchange server, the project server and/or one or more other file servers.

As will be appreciated, a message generated by an entity may be categorized into multiple message categories. For example, an RFID message may be used for both an identity registry and a location message, in which the location of a participant is determined.

The event manager 80 is configured to process information received in the input messages in accordance with a set of logic rules defined within the semantic framework 40, as described in above-incorporated International PCT Patent Application No. WO 2010/066023. The event manager 80 is configured to then generate various event control messages using the event controllers 80b. The event control messages generally control event equipment and event services. In the embodiment shown, the event controllers 80b include an event room controller, an event client controller, an event services controller, and an event log recorder. For example, the event room controller is configured to generate messages for powering a projector of IWB 14 on and off, and for powering the event room lights on and off. The event client controller is configured to generate messages for indicating the start and the end of the event, indicating that a participant has joined or left the event, and for indicating that the event client list has been updated. The event services controller is configured to generate messages for controlling the audio, video and data conference services.

The event manager 80 is in communication with an event database in which event-related data and rules are stored. Event manager 80 further comprises an event log recorder that is configured to record all messages in an event log 84 input into and output from the event manager 80. The event log 84 can be referred to for creating at least a portion of the minutes of the event.

The event manager 80 is also configured to generate messages for updating all event participants of the attendance status of the other event participants in near real-time. In this embodiment, the updates include information comprising identities of the participants and their locations, the roles or titles of the participants, and participant schedules relevant to the event, such as when a participant is expected to join or leave the event.

The event manager 80 is also configured to facilitate the progress of events in real-time by applying additional rules to input messages. In this embodiment, the additional rules are defined and modified by an event host. Several examples of applying additional rules for facilitating the progress of events in real-time are provided below.

For example, an event may be set up with an additional rule that, based on the collected information, screen sharing may begin automatically when a remote participant joins the event.

As another example, an event may be set up with an additional rule that requires a key participant designated by the event host to join the event prior to the start of the event. In this case, the event manager 80 checks the presence status of the key participant at the scheduled event start time. If the key participant has not joined the event, a message is then delivered to the IWB 14 and to all event participants to inform them that the event is delayed due to the absence of the key participant. The event manager 80 continues to monitor the presence status of the key participant, and starts the event only when the key participant joins the event (e.g., when the key participant's RFID is detected in the event room or when the key participant has joined the event remotely).

As another example, an event may be set up with an additional rule that requires a certain number of participants to have joined the event before the event can start. In this case, the event manager 80 monitors the number of participants that have joined the event and starts the event only when the specified number have joined.

As still another example, an event may be set up with an additional rule that, when the event manager 80 determines that a participant has left the event room, a message is sent to the IWB 14 and to all remaining event participants.

As yet another example, an event may be set up with an additional rule that the event manager 80 provides information to all event participants indicating the level, title and position of a participant joining the event.

As still yet another example, an event may be set up with an additional rule that, when the event manager 80 detects that a key participant is absent from the event, and an uninvited person from the same department of the absent key participant has joined the event, the event manager 80 will send a message to the event host to verify whether the uninvited person is a delegate of the absent key participant.

As another example, an event may be set up with an additional rule that, at an appropriate time, the event manager 80 will send an event room control message to the event client running on the general purpose computing device 12 to power on the required event equipment. Similarly, when the event manager 80 detects that an event is over, and no other event is scheduled to start in the same event room within a predefined time period, the event manager 80 will send an event room control message to the event client running on the general purpose computing device 12 to power off the event equipment.

As still another example, additional rules may be set up for allowing an ad hoc event. Here, the data acquisition layer 46 can detect one or more persons entering an event room, which is reported to the event manager 80 as a presence message. This will trigger the IWB 14 in the event room to display a booking status of the room, namely “booked” or “available”, together with a quick-start button that may be touched by a user to start an ad hoc event.

As will be understood, additional rules other than those provided in the examples above may be applied. As described in above-incorporated International PCT Patent Application No. WO 2010/066023, the semantics-based software architecture 30 is evolvable in that it can adapt according to requirement and resource changes. It thereby provides users high flexibility in scheduling and managing events, and greatly improves the usage efficiency of event resources.

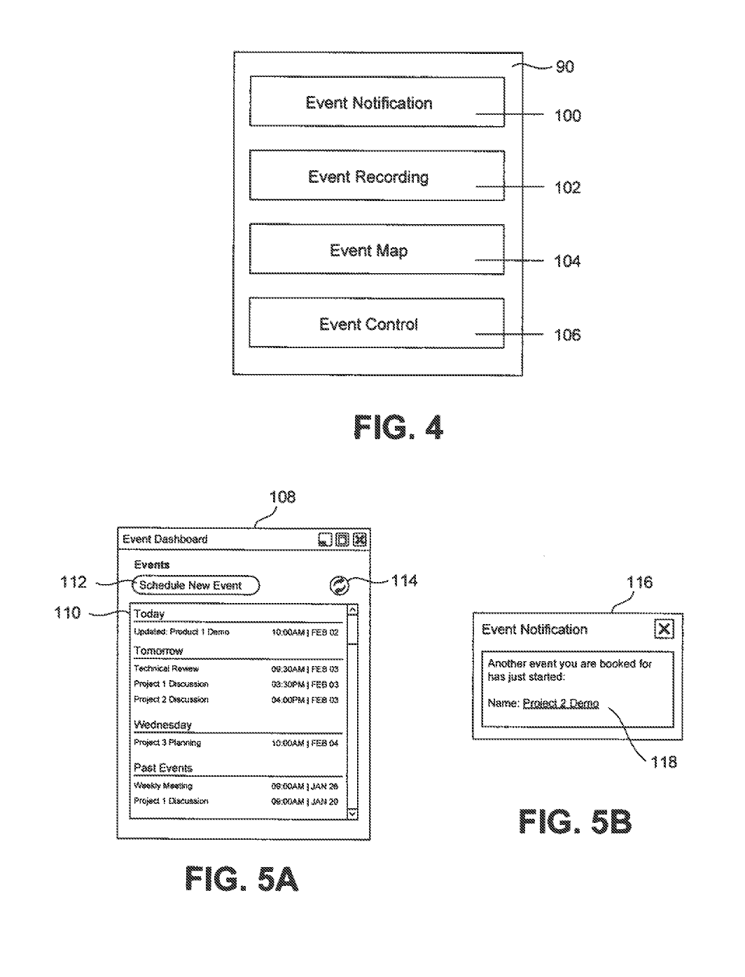

FIG. 4 shows event services provided by the system 10, and which are generally indicated by reference numeral 90. Event services 90 carried out by the event manager 80 and event clients, are generally grouped into four categories: namely an event notification service 100; an event recording service 102; an Event Map service 104, which maps the event resources of an event; and an event control service 106, which manages, schedules, and controls the progress of events. Of course, other event services may also be provided by the system 10.

The event notification service 100 informs users of the schedule, the progress and the status of events. Here, the general purpose computing device 12 and participant computing devices 18 are configured to run a notification receiver. The notification receiver is configured to receive a notification from the event server 20, and to display information from the notification on general purpose computing device 12 and on participant computing devices 18. In this embodiment, this information from the notification is displayed in the form of a window. FIG. 5A shows an event list window 108 that is displayed when a user logs in to the Event Dashboard application 42. The event list window 108 comprises a list 110 of past and future events, a refresh button 114, which may be selected to refresh the list 110, and a “Schedule New Event” button 112, which may be selected to schedule a new event. The events shown in list 110 may each be selected to view details of that event, such as for example the event facility, the event agenda, and associated projects. In this embodiment, each event shown in list 110 may also be modified by an authorized user. For example, an authorized user may schedule an event and then grant certain participants authorization to modify the event agenda, so that they can collaboratively revise the agenda using the Event Dashboard application 42 prior to the start of the event.

The event manager 80 monitors both participant locations and event schedules. If it is detected that a user is currently participating in a first event and a second event that the user is scheduled to attend has started, the event manager 80 sends a notification to that user as a pop-up bubble 116, as shown in FIG. 5B. Pop-up bubble 116 comprises the name 118 of the second event, which may be selected by the user to allow the user to leave the first event and join the second event.

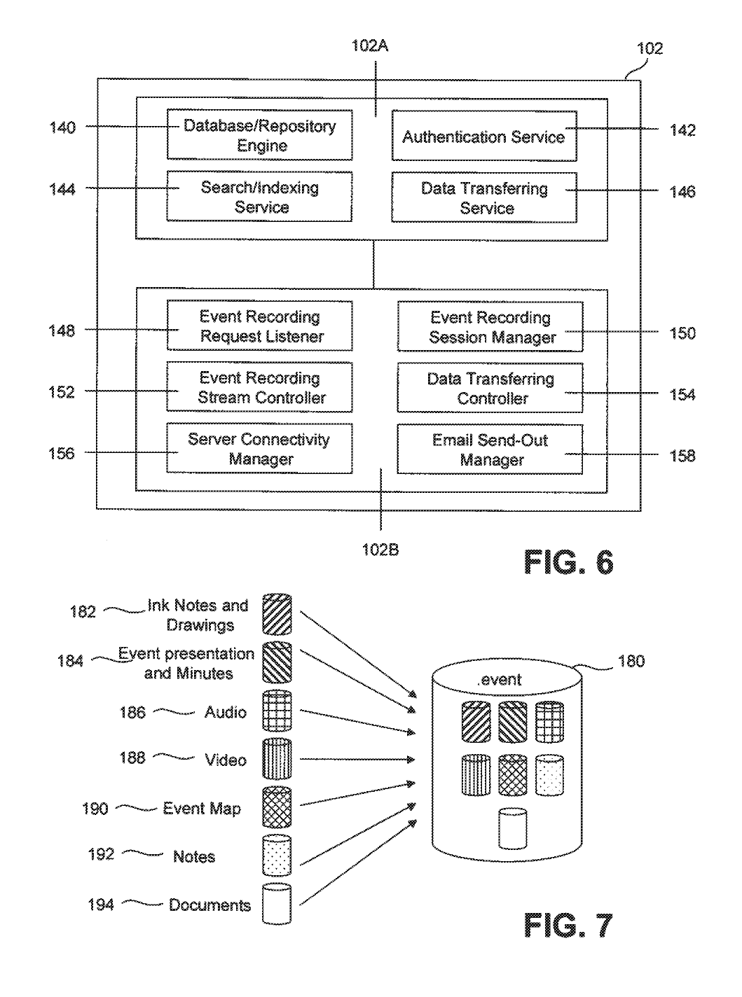

The event recording service 102 is shown in FIG. 6. The event recording service 102 is grouped into a server-side event recording service 102A and a client-side event recording service 102B. In this embodiment, the server-side event recording service 102A is provided by the event server 20, and the client-side event recording service 102B is provided by the general purpose computing device 12. The server-side and client-side event recording services 102A and 102B are configured to collaborate with each other to record event content.

The server-side event recording service 102A comprises a database/repository engine 140 that provides a central database/repository in which recorded event content is stored as event packages. In this embodiment, the database/repository engine 140 automatically archives event packages, and may also delete old event packages. The server-side event recording service 102A also comprises an authentication service 142, which provides services for establishing and maintaining simultaneous secure connections with concurrent client-side event recording services 102B for creating new event packages. Authentication service 142 also provides a secure login system for users and controls user access permissions. The server-side event recording service 102A also comprises a data transferring service 146, which provides services for uploading data from event content streams, such as data, video and audio streams, to the database/repository engine 140. The data transferring service 146 also processes data or file download requests from users. The server-side event recording service 102A also comprises a search/indexing service 144, which provides a search engine for searching recorded event content. The server-side event recording service 102A collaborates with the event manager 80 to record the event log.

The client-side event recording service 102B is started and terminated by the client-side event management applications running on general purpose computing device 12, namely the Event Dashboard application 42. Upon being started, client-side event recording service 102B runs in the background and records event content, and then uploads it to the database/repository engine 140 via the data transferring service 146. Multiple instances of client-side event recording service 102B run on the general purpose computing device 12 when serving consecutive events. For example, if a second event starts while a first instance of the client-side event recording service 102B is still uploading the recorded content of a first event to the database/repository engine 140, then a second instance of the client-side event recording service 102B begins recording the second event. The two instances will run simultaneously until the uploading of the recorded content of the first event has been completed, upon which the first instance of the client-side event recording service 102B is terminated.

The client-side event recording service 102B comprises a set of event listeners and controllers. In the embodiment shown, the set of event listeners and controllers comprises an event recording request listener 148, an event recording session manager 150, an event recording stream controller 152, a data transferring controller 154, a server connectivity manager 156, and an email send-out manager 158. The event recording request listener 148 is configured to receive requests to start and end the event recording sent by the Event Dashboard application. The event recording session manager 150 is configured to start an event recording session upon receiving an event record request, and to terminate the session upon receiving an event end request. In this embodiment, the event recording session manager 150 is also configured to establish streams to be recorded which, depending on the resources used during the event and the event recording configuration, may comprise any of data, audio and video streams, to store them on the general purpose computing device 12, and to terminate the streams when the recording session is terminated. Here, the streams established will depend on both the resources used during the event and the event recording configuration, and may comprise any of data, audio and video streams. Each stream is cached on the general purpose computing device 12 as a separate temporary file.

The event recording stream controller 152 is configured to control the streams and to save the recorded data into respective files in the cache. In this embodiment, the event recording stream controller 152 controls recording settings such as frame rate, image size, audio quality, compression ratio, and encoder type, namely a loss- or lossless-encoder type. The server connectivity manager 156 is configured to establish connection with the server-side event recording service 102A for enabling uploading of the recorded event content to the event server 20, and to terminate the connection when the uploading has been completed. The data transferring controller 154 is configured to manage the uploading of the recorded event content by sending requests to the server-side event recording service 102A for creating a new event package, for beginning, ending, pausing and continuing the uploading session, and for finalizing the event package. The data transferring controller 154 also encrypts/encodes the uploaded data. The email send-out manager 158 is configured to collaborate with the Event Dashboard application to insert a link of the recorded event package into end-event emails, which are further described below. The client-side event recording service 102B notifies the event management application when the event recording session has ended.

The server-side and client-side event recording services 102A and 102B allow the full content of the event to be recorded, but may also allow only certain types of content of the event to be recorded. The certain types of content to be recorded are defined by equipment resource availability. Referring again to FIG. 2, based on the information obtained from the data acquisition layer 46, the semantic framework 40 determines default event recording settings for each event room according to the equipment resources available therein. For example, video stream recording will not be enabled if the event room is not equipped with a video camera. In this embodiment, the default event recording settings may be modified by a system administrator.

FIG. 7 shows an example of event content that is recorded during an event. In the example shown, the event content recorded during the event comprises: digital ink 182; event notes and minutes 184, such as presentation slides for example SMART Notebook™ pages; event audio 186; event video 188, which comprises one or more video streams, such as for example a video stream played in the event and/or a video stream captured by the camera in the event room; an Event Map 190; comments 192 sent between event participants; and documents 194 attached to or used in the event. The recorded event content is bundled into an “.event” package 180 that is stored in the database/repository 82. The package 180 is indexed to allow users to search for desired information.

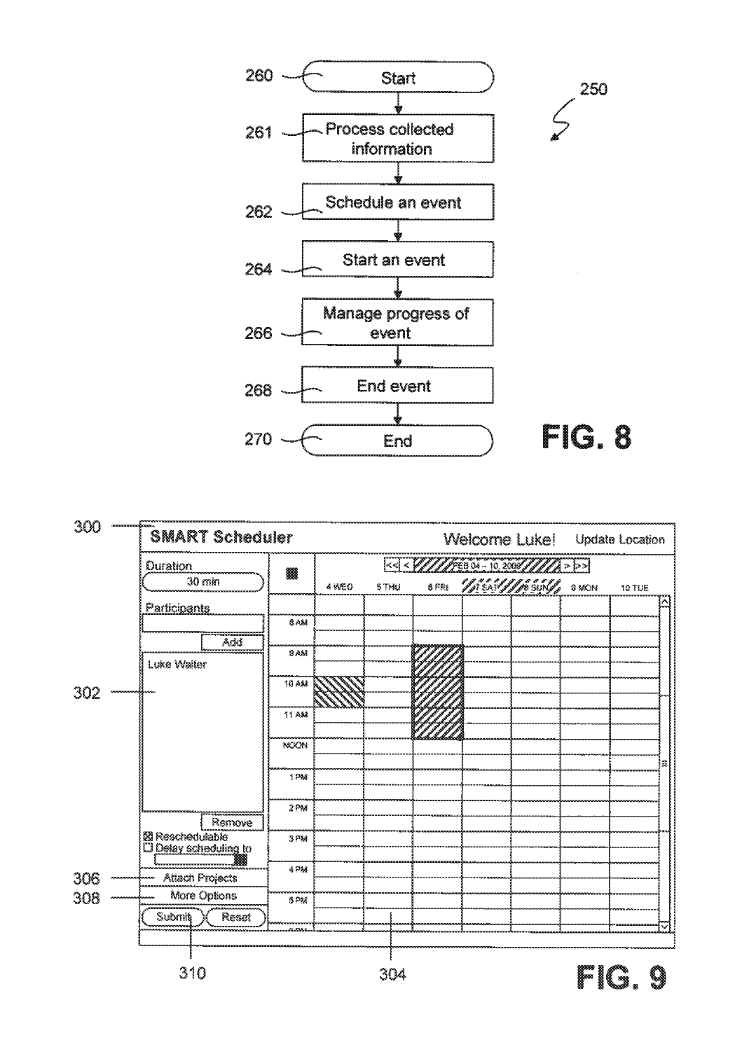

FIG. 8 is a flowchart showing steps in an event management process used by the event manager 80 for managing an event, and which is generally indicated by reference numeral 250. When the event management process 250 starts (step 260), information collected from the data acquisition layer 46 is processed by the event manager 80 (step 261). An event is then scheduled (step 262) using the Event Scheduler based on the information processed in step 261.

Prior to the start of a scheduled event, event start criteria requirements are checked. The event start criteria require that the event resources, including the event room and the event room equipment, be available. Additionally, the event start criteria may include any further criteria defined using additional rules, such as for example the presence of a key participant, or for example the existence of a quorum. If all of the requirements are met, the event is then started (step 264). Once the event has been started, the event manager 80 collaborates with event clients to manage the progress of the event (step 266). When the event host terminates the event, the event manager 80 executes an event clean-up routine and ends the event (step 268). Here, the event clean-up routine comprises generating at least a portion of the event minutes, saving the event minutes, updating participant and event room schedules, and releasing the resources used in the event. The event management process 250 then ends (step 270).

The event management process 250 is executed at both the server and client sides. As described above, in this embodiment, the server side comprises the event server 20 and the audio, video and data servers 22, namely the SMART Bridgit™ conferencing server and the Cisco MeetingPlace server. The client side comprises the Event Scheduler and Event Dashboard applications run on the general purpose computing device 12 and participant computing devices 18. Users who do not have a participant computing device 18 may attend the event in the scheduled event room, or may dial in to the voice bridge.

The Event Scheduler application used herein is generally similar to the Meeting Scheduler described in above-incorporated International PCT Patent Application No. WO 2010/066023. When scheduling an event, a user is required to input only certain event criteria, such as for example, a list of participants and a preferred time range. The Event Scheduler application then determines the parameters of the event such as suitable time slots within the preferred time range, and event rooms and resources that are available during the suitable time slots. The Event Scheduler application is configured to adapt to user preferences by monitoring a preference pattern for each user, and by providing a set of event resources that match each user's preferences as a default option for that user to select. When scheduling the event, the user may select the default option or may select another set of options. The Event Scheduler application may also be configured by a user to automatically schedule an event according to that user's preferences, so as to more efficiently utilize the resources within the organization.

The Event Scheduler application determines participant locations based on information collected from the data acquisition layer 46. For example, participant location may be determined from a user's office location registered in an LDAP server of the organization. As another example, a given user's presence information as detected by an RFID sensor and collected by the data acquisition layer 46 may exhibit a pattern indicating that the user works at a first location on Mondays and Tuesdays, and works at a second location on Wednesdays, Thursdays and Fridays. When scheduling an event, the Event Scheduler application refers to the participant locations determined from the information collected by data acquisition layer 46 to decide whether any of audio, video and data bridges should be booked and, if so, on which servers they should be booked. For example, if all participants are within a single building, no audio, video or data bridges are booked. If participants are within two or more buildings of the same organization, any of video and data bridges will be booked at an internal conferencing server of the organization. If one or more participants are external to the organization, any of audio, video and data bridges are booked at one or more external conferencing servers, if available. An event host may also manually book the audio, video and data bridges at conferencing servers, as desired.

FIG. 9 shows an Event Scheduler window, and which is generally indicated by reference numeral 300. Event Scheduler window 300 provides a user interface through which a user, such as an event host, may schedule an event and select settings for the event. Event Scheduler window 300 comprises a list 302 of event participants selected by the user to participate in the event. Event Scheduler window 300 also has a calendar 304 comprising an array of time slots, each of which may be selected for designating a date and time range in which an event is to be scheduled. Upon entering a date and time range, suitable time slots within the entered date and time range in which all participants of list 302 are available, and one or more event rooms available within those suitable time slots, are determined and presented to the user for selection (not shown). If no suitable time slot is available within the entered date and time range, Event Scheduler window 300 displays an advisory (not shown).

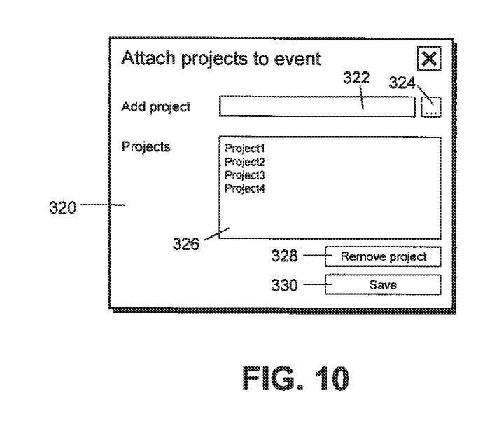

Event Scheduler window 300 also comprises an Attach Projects button 306, which may be selected for attaching one or more projects to the event. Clicking on the Attach Projects Button 306 causes an Attach Projects window to be displayed, which is shown in FIG. 10 and is generally indicated by reference numeral 320. Attach Projects window 320 comprises a text input box 322, in which a name of a project may be entered, a search button 324 that may be selected for finding a project, and a list 326 showing projects that are selected for attachment. Attach Projects window 320 further comprises a Remove project button 328, that may be selected for deleting projects from the list 326, and a “Save” button 330 that may be selected for attaching the projects shown in list 326 to the event.

Turning again to FIG. 9, Event Scheduler window 300 also comprises a More Options button 308, which may be selected for adjusting other settings of the event, such as for example for selecting one or more event room facilities such as for example projectors, IWBs, and audio and video devices; for selecting one or more conferencing servers; and for attaching one or more files to the event. Event Scheduler window 300 further comprises a submit button 310, which may be selected for scheduling the event according to the selections made using the Event Scheduler window 300, namely the event settings.

Once the event has been scheduled, the event settings are stored in the event server 20. The identities (IDs) of any projects attached to the event and links to any files attached to the event are also stored in the event server 20. Additionally, and as described in above-incorporated International PCT Patent Application No. WO 2010/066023, the schedule of each of the event resources is updated in the Exchange Server to indicate the event during the selected time slot.

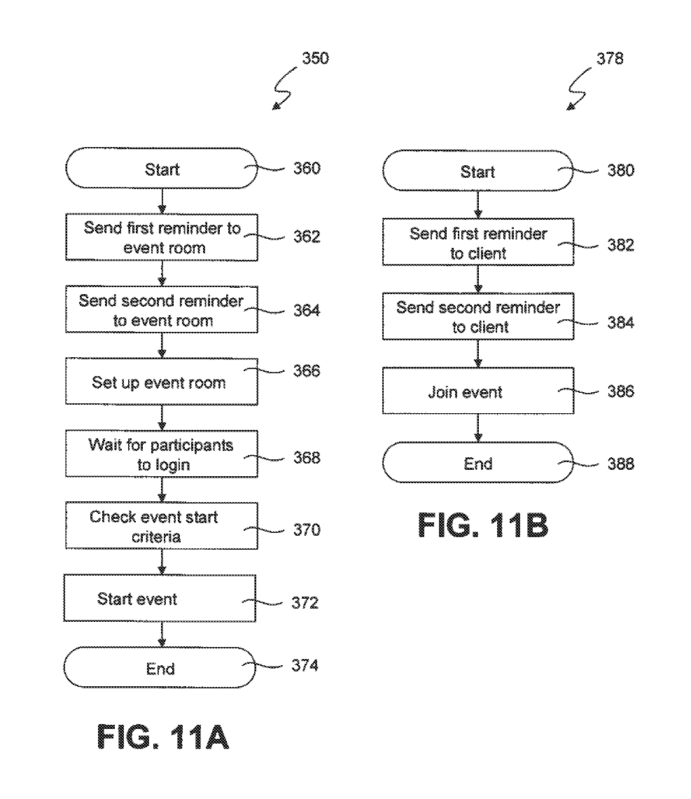

A process used for starting an event at the event server 20 is shown in FIG. 11A, and is generally indicated by reference numeral 350. The event server 20 starts the event at a first time threshold prior to the scheduled event start time (step 360). In this embodiment, a default value of the first time threshold is fifteen (15) minutes. The value of the first time threshold is adjustable by an authorized user, such as the event host or the system administrator. After starting, the event server 20 sends a first message to the booked event room (step 362), indicating that an event will begin after a time corresponding to the first time threshold. Upon receipt of the first message, indication of receipt of first message is presented in the event room, and in this embodiment, this indication comprises one or more of a message that is displayed on the IWB 40 in the event room, a change in the lighting of the event room, and an audio signal output on speakers in the event room, for example. The indication is intended to encourage any current users of the event room to finish their event, and to make any user desiring to start an ad hoc event in the event room aware that the event room is not available for longer than the first predefined time threshold.

At a time corresponding to a second time threshold prior to the scheduled event time, the event server 20 sends a second message to the event room (step 364), indicating that the event will begin after that time. In this embodiment, the default value of the second time threshold is five (5) minutes. The value of the second time threshold is also adjustable by the authorized user. If the event manager 80 determines based on information from data acquisition layer 46 that another event is currently being held in the event room, the event manager 80 will prompt those event participants to terminate the event and to vacate the event room.

If the event room is available at the scheduled event time, the event manager 80 sets up the event room (step 366). The event room may become available when any previous event has been terminated, or when the event room is detected as being vacant, such as for example when sensors 26 in the event room detect no persons in the event room. In this step, the event manager 80 sends a wake-up message to any event resources in stand-by mode to wake them up. These event resources may include, for example, the general purpose computing device 12, IWB 40, a projector, and audio/video devices. After sending the wake-up message, the event manager 80 then establishes an event session and displays a dialogue box on the IWB 40 comprising a button that may be selected, such as by the event host, for starting the event. The event manager 80 also displays on IWB 40 a schedule of the event room, showing the current event and subsequently scheduled event, together with the respective event hosts.

During step 366, the server-side event recording service 102A establishes a connection to the client-side event recording service 102B running on the general purpose computing device 12, initiates uploading of recorded event streams, and collaborates with the event manager 80 for starting recording of the event log.

Once the event room has been set up, the event manager 80 waits for event participants to login (step 368). During participant login, the event manager 80 monitors which participants have logged in and checks the event start criteria (step 370). As mentioned previously, the event start criteria may require, for example, that a key participant be present before the event can start.

Once the event start criteria has been satisfied, the event manager 80 starts the event (step 372). At this step, if a voice bridge is booked, the event server 20 instructs the voice conferencing server to establish the voice bridge by automatically dialing a telephone in the event room. The event server 20 also instructs the data and video conferencing server 22 to establish data and video bridges, as needed. In this embodiment, no data bridge will be established until the event manager 80 detects that two or more participant computing devices 18 have joined the event, after which a data bridge, such as for example a Bridgit™ meeting, is automatically created for enabling data sharing. Additionally, a video bridge is established only when one or more video cameras are detected in the event room.

At step 372, the event manager 80 also automatically locates and retrieves files that are attached to the event according to links stored in the event server 20, and also refers to stored project IDs to retrieve information of projects attached to the event from a project database. In this embodiment, the project database is an external database stored on a server 24. Links to project information, such as information queries, folders and files, are generated and attached to the event session. Here, the information about the projects may include, for example, the project schedule, the project progress, project team members, project agenda, project financial data and project documents. Each link generated may be selected for accessing a linked query in the project database, and for opening a linked file or folder stored in the project database.

At step 372, the event manager 80 also starts the client-side event recording service 102B in the general purpose computing device 12. In this embodiment, the general purpose computing device 12 is used by the event host during the event. The client-side event recording service 102B is started according to a set of default event recording settings that are determined based on the hardware and software resources being used and on the configuration of remote event participants. The event recording settings are also adjustable by the event host. The client-side event recording service 102B connects to the server-side event recording service 102A with a request to create a new event package, starts the event recording session, and initializes the streams according to the event recording settings. These streams may be any of, for example, data, audio, and video streams. Process 350 ends once the event has been started (step 374) following which the event manager 80 monitors and facilitates the progress of the event.

A parallel process for starting the event at the event client side is shown in FIG. 11B, and is generally indicated by reference numeral 378. At the event client side, the process starts at a time corresponding to the first time threshold prior to the scheduled event start time (step 380). The event client sends a first message to indicate that the event will begin after a time corresponding to the first time threshold (step 382). In this embodiment, the first message is displayed on each participant computing device 18 in the form of a message bubble. The event client then sends a second message to indicate that the event will begin after a time corresponding to the second time threshold (step 384). The second message is also displayed on each participant computing device 18 in the form of a message bubble. Once the user has joined the event (step 386), the event start process on the event client side ends (step 388).

During user login in steps 368 and 386, information collected by the data acquisition layer 46 is used to verify user identity. In this case, information obtained by the data acquisition layer 46 pertaining to user presence, user location and user identity is analyzed by the semantic framework 40 to identify both the user and the participant computing device 18 of that user. As an example, when a user logs in to the event using a participant computing device 18, the user is identified by his or her user name. The IP address of the participant computing device 18 is then used to associate the user with his or her participant computing device used during the event. As another example, when a user scans his or her RFID tag at an RFID reader attached to the IWB 14, the user's identity is determined from the RFID information and the IWB 14 is associated with the user as his or her participant computing device 18 used during the event. Once the identities of the user and of the user's participant computing device have been determined, the event manager 80 joins the user and the participant computing device 18 to the event, and connects the participant computing device 18 to the data bridge of the event if a data bridge is used.

User login is generally facilitated by semantic framework 40 through analysis of information collected by the data acquisition layer 46. The semantic framework 40 determines participant location information by synthesizing information obtained from, for example, participant RFID tags, GPS devices installed on the participant computing devices 18, location information relating to participant cellphones as provided by the cellular network, and location information pertaining to participant computing devices 18 provided by the wireless router or access point. As is well known, cellular network operators can provide location information of cellphones within the cellular network with permission from the service provider. In areas having multiple wireless routers/access points at known locations, the approximate location of a participant computing device connected to one of the wireless routers/access points can be determined based on the location of the wireless router/access point to which the participant computing device is connected. The semantic framework 40 also determines participant location based on any of patterns within participant schedules, historical location information, and rules relevant thereto.

When a user logs in to an event, the semantic framework 40 uses the user's location information to automate the set up for the user. For example, if the semantic framework 40 determines that a participant is located in the event room, then the semantic framework 40 will not attempt to establish a connection between the participant computing device 18 used by that participant and the voice or video bridge of the event. However, if the semantic framework 40 detects that a participant is not located in the event room, then the semantic framework 40 will attempt to find a phone number of that participant based on the analysis of the location information, rules relevant to, and the historical pattern of that participant. If a phone number is found, the semantic framework 40 will automatically instruct the voice conferencing server to dial the number and establish an audio connection between the user and the voice bridge of the event. If a phone number cannot be found, the user is then asked to provide a phone number for the voice conferencing server to dial. In this example, the user manually enters a phone number or selects a number from a list of phone numbers, such as for example a list of recently used numbers or a phone number list of the organization. The user can also manually dial in to the voice bridge. Similarly, the semantic framework 40 can also automatically establish a video connection between the user and the video bridge of the event, as needed.

Once an event has started, the event manager 80 monitors the presence status of event participants, and terminates any data, voice and/or video connections of any participant who leaves the event. The event manager 80 counts the number of connections to the data, voice and video bridges, respectively, and automatically closes a bridge if there is only one connection therein.

In this embodiment, the Event Dashboard application is installed on and runs on client computers, namely on general purpose computing device 12 and on participant computing devices 18. The Event Dashboard application presents lists of event participants and event resources associated with the event, together with additional information obtained from the semantic framework 40 based on information collected from the data acquisition layer 46. In this embodiment, this additional information comprises any of current usage status of an event room, current location of each participant, whether a participant is in another concurrent event, whether a participant has logged into the Event Dashboard application running on another participant computing device, whether a participant is currently using a phone, comment board activity status of each participant, and whether a participant is out of the office or is indicated as being on vacation in his or her calendar, such as for example in a Microsoft Outlook® calendar. The current location of each participant is based on information obtained from any of a GPS device, a cellphone, an RFID tag, any other location tracking means carried by the participant, and a wireless router/access point.

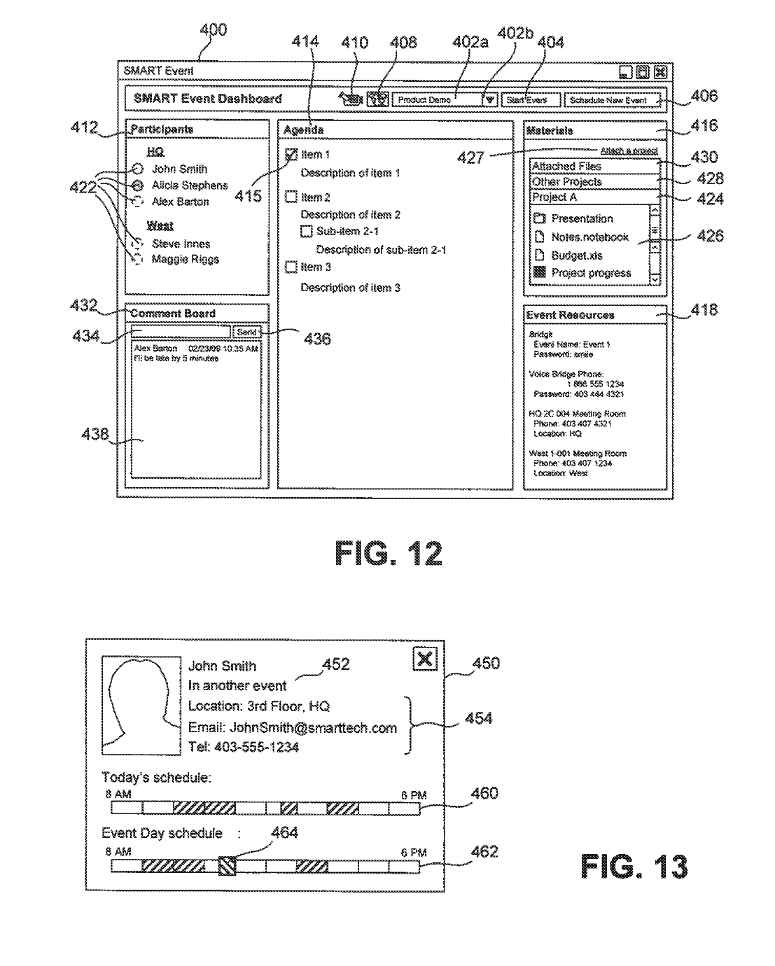

The Event Dashboard application comprises an Event Dashboard interface presented as an Event Dashboard window, which is shown in FIG. 12 and is generally indicated by reference numeral 400. Event Dashboard window 400 is presented to participants on their respective participant computing device 12 or 18 after logging in to the Event Dashboard application. Event Dashboard window 400 comprises a dropdown menu button 402a that may be selected for listing events scheduled for that user. Event Dashboard window 400 also comprises a plurality of buttons, including a button 404 that may be selected for starting, joining, terminating or quitting an event, depending on the current status of the participant, a button 406 for scheduling a new event, a button 408 for showing an Event Map and a button 410 for adjusting event recording settings.

Event Dashboard window 400 further comprises a display field 402a showing either the current or the next event scheduled for a user, according to whether or not the user is currently in an event. The user may select an event from the dropdown menu button 402b to show details of that event in the Event Dashboard window 400. If the event indicated in display field 402a is the current event and the user is the event host, button 404 displays “Terminate event” allowing the event host to select the button 404 to terminate the event. If the event indicated in display field 402a is the current event and the user is not the event host, button 404 displays “Quit event” allowing the user to select the button 404 to leave the event. If the event indicated in display field 402a is a scheduled event that has not started and the user is the event host, button 404 displays “Start event” allowing the user to select the button 404 to manually start the event. If the event indicated in display field 402a is a scheduled event and the user is not the event host, button 404 shows “Join event” allowing the user to select the button 404 to join the event. In this embodiment, the event manager 80 automatically terminates the user from a current event before it joins the user to a selected event.

Event Dashboard window 400 also comprises a list of event participants 412, an Agenda 414 of the event, a Materials section 416 in which projects and files attached to the event are listed, and a list of event resources 418. Event Dashboard window 400 also comprises an interactive comment board 432, which generally serves as a chat-room in which the participants may send notes to one or more designated participants in real time.

In the embodiment shown, the participants in list 412 are organized according to physical location. List 412 comprises indicators 422 for indicating the status of each participant. In this embodiment, the status refers to whether the participant has or has not joined the event. Each of the participants shown in list 412 may be selected by the user for displaying a Participant Information window, as shown in FIG. 13 and generally indicated by reference numeral 450. Participant Information window 450 comprises additional information about a selected participant and, in the embodiment shown, Participant Information window 450 indicates a current event status 452 of the participant. The event status may be any one of in the current event, in another event or not in an event. Participant Information window 450 also indicates current contact information 454 of the participant, such as for example the location, email address, phone number, and schedule of the event. In the embodiment shown, if the date of the event indicated in display field 402a of Event Dashboard window 400 is not the current date, then Participant Information window 450 displays both a current day schedule 460 and an event day schedule 462 for the participant. Participant Information window 450 also comprises an indicator 464 showing the time slot in which the event is scheduled.

Turning again to FIG. 12, the Materials section 416 of Event Dashboard window 400 comprises an “Attach a project” link (not shown) that may be selected for attaching a project to the event, an “Attached Files” button 430 that may be selected for viewing details of files attached to the event, and an “Other Projects” button 428 that may be selected for viewing a project attached to the event. In the embodiment shown, “Project A” has been selected, causing the name of this project to be displayed in a project name field 424 and the details of the project to be displayed in list 426. Each item displayed in the list 426 is a link to a folder, a file, a web page, a task or a query associated with Project A, and may be selected for accessing the linked item. In this embodiment, files associated with projects are stored in the project database.

The Event Dashboard application monitors any and all files, web pages, whiteboard pages displayed on IWB 14, and any other pages that are created or opened during the event, and instructs the client-side event recording service 102B to record them. The Event Dashboard application automatically attaches these files and pages to the event if the event belongs to a series of recurring events that has been scheduled over multiple days, or if the event is extended or is rescheduled to a future time, so that these files and pages will be accessible via the Attached Files button 430 when the event starts again.

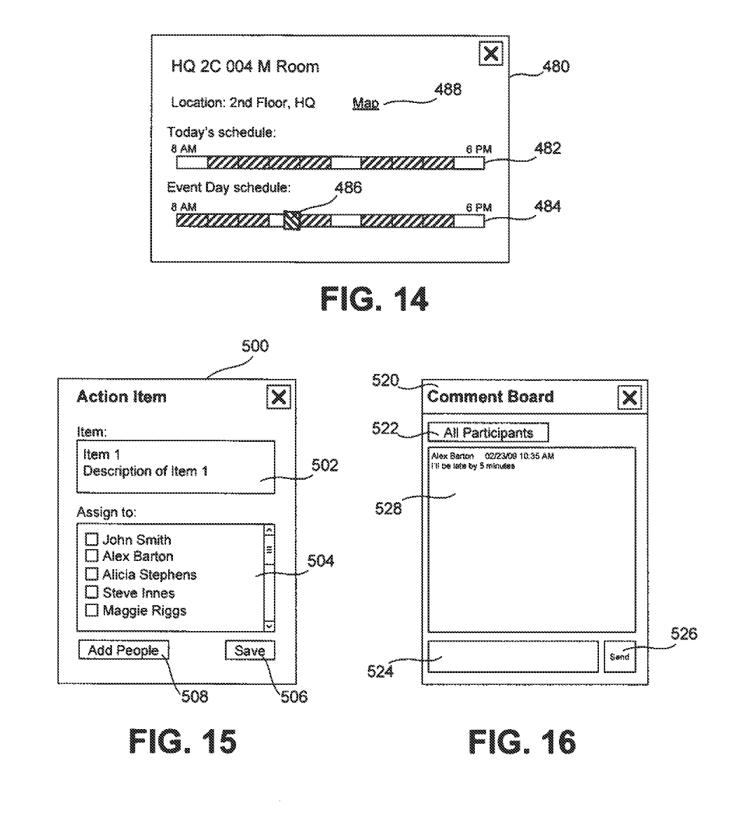

The Event Resource list 418 of Event Dashboard window 400 comprises information about the event rooms, the equipment available in the event rooms, and any data, voice and video bridges of the event. In the embodiment shown, a data bridge is provided on the SMART Bridgit™ conferencing server, and a voice bridge is provided by a separate voice conferencing server. The Event Resource list 418 also shows the Bridgit™ meeting name and password, as well as the voice bridge phone number and password. Each of the items shown in the Event Resource list 418 may be selected for displaying a window showing further information. For example, selecting an event room name displays an Event Room window 480, as shown in FIG. 14. Event Room window 480 comprises fields in which the name, location and schedule of the event room are displayed. Event Room window 480 also comprises a link 488 to a building map for enabling the event room to be more easily located. If the event date is not the current date, both a current day schedule 482 and an event day schedule 484 are shown. Event Room window 480 also comprises an indicator 486 showing the time slot in which the event is scheduled.

Turning again to FIG. 12, Agenda 414 comprises a list of items to be discussed during the event. In this embodiment, the items listed in the Agenda 414 are used by the event manager 80 for generating, in part, event minutes at the end of the event. Each of the event participants is able to edit the Agenda 414. The editing comprises any of modifying items, adding notes, and checking-off items as they are completed. Because all participants can edit the Agenda 414, the editing is collaborative between participants and can be carried out using various approaches, such as for example real-time democratic updates or locking techniques. Such approaches are well known in the art. Individual participants can be assigned to individual agenda items by dragging a participant name listed in list 412 and dropping it onto an item listed in Agenda 414, or by dragging an item listed in Agenda 414 and dropping it onto a participant name listed in list 412. Additionally, each of the items listed in Agenda 414 may be selected by double-clicking for assigning the item to one or more participants by an Agenda Item Assignment window, which is shown in FIG. 15 and indicated by reference numeral 500. Agenda Item Assignment window 500 comprises an item description box 502 showing a description of the agenda item, and a list 504 of persons that includes all event participants and other persons not participating in the event but who are added to the list using the “Add People” button 506. Selecting a check box adjacent a person displayed in list 504 and clicking on save button 506 causes the agenda item to be assigned to that person.

Turning again to FIG. 12, each of the items listed in Agenda 414 comprises a respective tick box 415 that may be selected for designating that item as completed. Information about the event, such as for example the names of the event participants, the completed agenda items, and the time at which an agenda item was completed, is recorded by the event manager 80 in the event log 84. If the event is a recurring event, any uncompleted agenda items are automatically forwarded to the next recurrence of the event.

Event Dashboard window 400 also comprises a comment board 432 through which event participants may exchange comments. The comment board 432 comprises an input box 434 in which comment text may be entered by a user, and also comprises a send button 436 that may be selected for sending the entered text as a comment to designated event participants. Sent comments and received comments are displayed in a dialogue box 438.

The comment board 432 of Event Dashboard window 400 is configured to be dragged and dropped so as to create a separate Comment Board window 520, as shown in FIG. 16. Comment Board window 520 comprises a button 522 that may be selected to provide a list of participants, from which one or more participants may be designated for receiving a comment. Comment Board window 520 also comprises an input box 524, a send button 526, and a dialogue box 528, which are generally similar to input box 434, send button 436 and dialogue box 438, respectively, of comment board 432. All sent comments are saved by the Event Dashboard application, however only the comments sent to the participant or participants identified on button 522 are displayed in the dialogue box 528.

Comment Board 432 and Comment Board window 520 enable event participants to exchange comments in real time, and can serve as a bulletin board of the event through which participants may post comments and reply to comments before, during and after the event. For example, a participant may send a comment to all participants prior to the start of the event stating that he or she will be late for the event.

Turning again to FIG. 12, Event Dashboard window 400 also comprises an Event Map button 408 that may be selected to display an Event Map. The Event Map is an image that generally shows the status of, and relationships between, resources of an event. Here, the event resources are represented in the Event Map as nodes, and relationships between the resources are represented by arrows between the nodes.

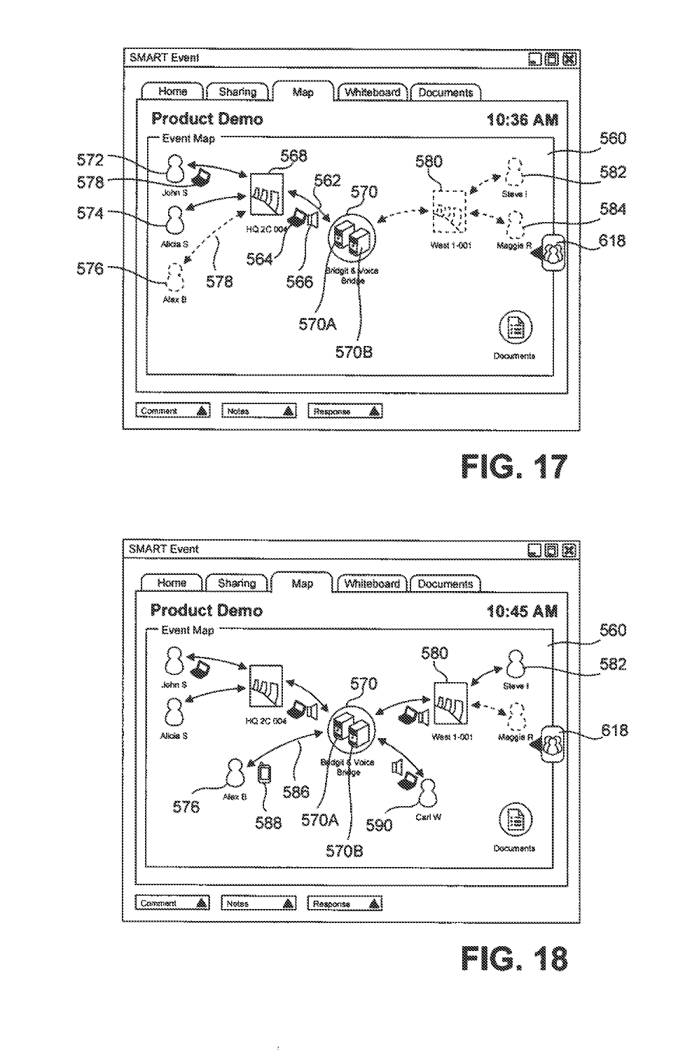

FIG. 17 shows the Event Map 560 of an event scheduled for five participants 572, 574, 576, 582 and 584 using two event rooms, namely event room 568 and event room 580. According to the event settings, participants 572 to 576 are expected to join the event from the event room 568, and participants 582 and 584 are expected to join the event from the event room 580.

In the embodiment shown, resources that have joined the event are indicated using icons having solid lines, and the relationships between these resources are indicated using solid line arrows. Resources that are assigned to the event but have not yet joined are indicated using icons having dashed lines, and the relationships therebetween are indicated using dashed line arrows. In the example shown, the event room 568 is indicated in solid lines, signifying that the meeting room has joined the event, and the solid line arrow 562 indicates that the event room 568 has connected to the audio, video and data server 570. Here, the solid line arrow 562 is associated with a computer icon 564, indicating a data connection to the Bridgit™ server 570A, and a speaker icon 566, indicating a voice connection to a separate audio conferencing server 570B. Participants 572 and 574 are connected to the event room 568 by solid line arrows, indicating that they are present within the event room 568. The presence of participants 572 and 574 in event room 568 is based on information collected by the data acquisition layer 46, such as for example input messages from sensors 26 in the event room 568. Participant 572 has also established a Bridgit™ connection to the Bridgit™ server 570A, as indicated by the computer icon 578. Participant 574 has joined the event without any Bridgit™ or voice connection to event room 568, as indicated by an absence of any such indicator icon. This relationship can result, for example, by participant 574 attending the event in the event room 568 without using any participant computing device. In this case, participant 574 is still able to collaborate with other participants by using the IWB 14 or any other audio/video devices that are available in the event room 568. Additionally, in the embodiment shown in FIG. 17, participants 576, 582 and 584, and the event room 580 have not yet joined the event, as indicated by dashed lines.

Event resources are continuously monitored during the event, and the Event Map 560 is continuously updated during the event to show any change in status of event resources. For example, FIG. 18 shows the Event Map 560 after being updated following several status changes. As illustrated, the participant 582 and event room 580 have joined the event. Participant 576 has also joined the event by using a mobile device, as indicated by solid line arrow 586 and mobile device icon 588. Solid line arrow 586 directly links the participant 576 to the Bridgit™ and audio conferencing servers 570A and 570B, which indicates that participant 576 has joined the event remotely using a mobile device instead of being present in either of the event rooms 568 and 580. The updated Event Map 560 shown in FIG. 18 also shows the appearance of a participant 590 who was not scheduled to participate in the event, but who has joined the event.

Event Map 560 is configured to display information pertaining to icons shown therein when a mouse cursor is hovered over an icon by a user. For example, and with reference to FIG. 18, hovering the mouse cursor over the icon of a participant causes the participant's phone number, email address, location, status and schedule to be displayed (not shown). Similarly, hovering the mouse cursor over the Bridgit™ server 570A of icon 570 causes the Bridgit™ event name and password to be displayed (not shown), and hovering the mouse cursor over the voice conferencing server 570B of icon 570 causes the voice bridge phone number and password to be displayed (not shown). Additionally, a user may use the Event Map 560 to establish a voice connection to the event by selecting the voice conferencing server icon 570B, after which the voice conferencing server dials the phone number registered for that user in another server 24, such as the employee database server.

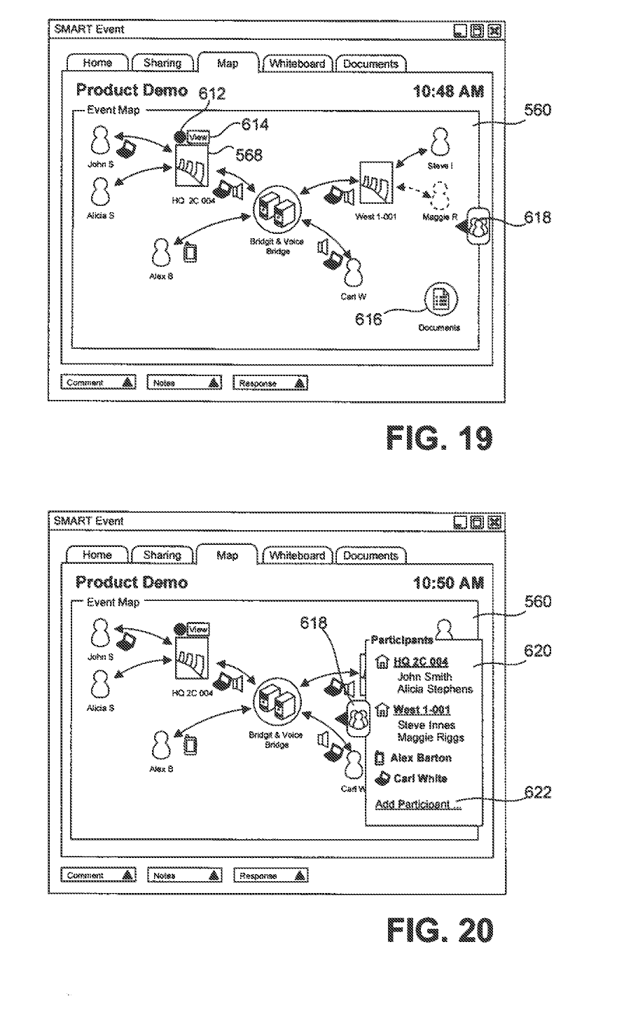

During the event, participants may share data on their respective participant computing devices 18 or general purpose computing device 12 with each other. Shared data can be in the form of, for example, a computer desktop, an application window, or files or folders stored on local computer or network drives. Nodes that are sharing data are indicated on the Event Map 560. FIG. 19 shows a further updated Event Map 560, in which event room 568 has associated with it an icon 612 and a button 614, indicating that an event resource within the event room 568 is currently sharing data. The event resource may be, for example, IWB 14. Button 614 may be selected for accessing the shared data. In the embodiment shown, Event Map 560 also comprises a documents button 616, which may be selected for accessing files and projects attached to the event. Clicking on documents button 616 displays a pop-up menu comprising links to the attached files and links to project information, which may include folders, files, and queries of the projects.

Event Map 560 also comprises an invitation button 618. Invitation button 618 may be selected for sending invitations to the event. Clicking on invitation button 618 displays a participant list 620, as shown in FIG. 20. Participant list 620 displays event participants, grouped according to both their physical location and device capabilities. Participant list 620 also comprises an add participant link 622. Selecting the add participant link 622 causes a directory of all persons in the organization to be displayed, each of which may be designated for invitation to the event. An invitation email comprising both the Bridgit™ meeting name and password, and the voice bridge phone number and password, is sent to the designated persons.

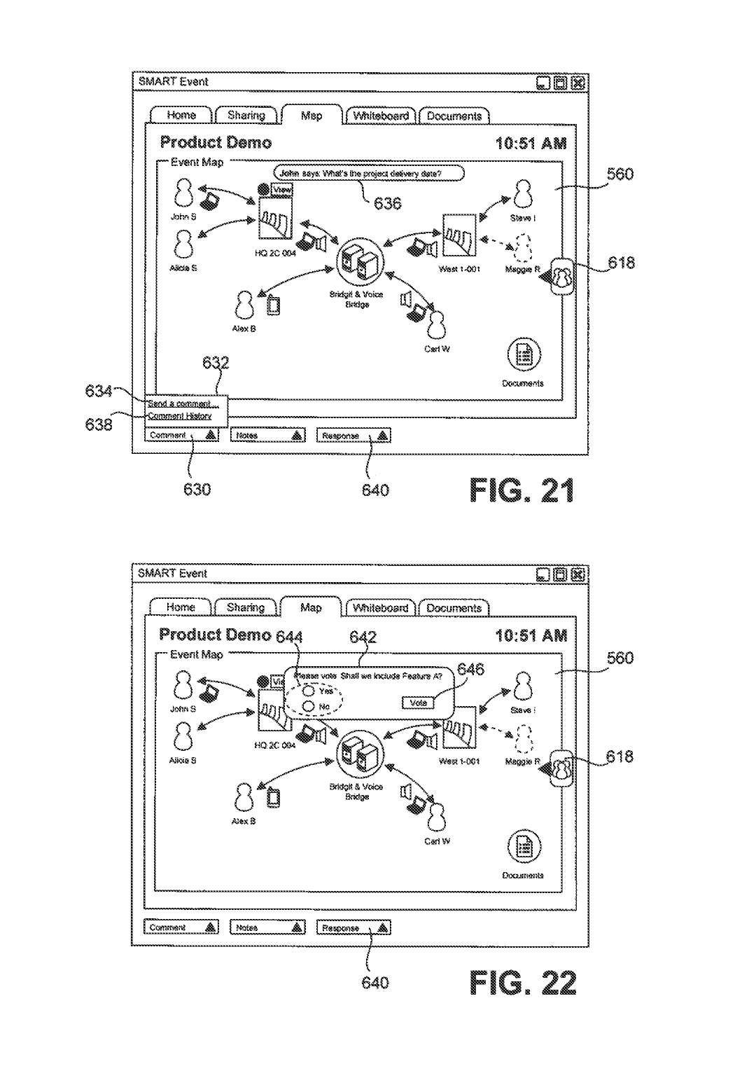

Event Map 560 provides a plurality of additional functions for enabling event participants to collaborate during the event. The additional functions are accessed by selecting buttons provided on Event Map 560, as shown in FIG. 21. In the embodiment shown, Event Map 560 comprises a comment button 630, which may be selected for displaying a pop-up menu 632 comprising a “send a comment” command button 634. The “send a comment” command button 634 may be selected for sending a comment to other participants. The comment appears as a pop-up bubble 636 for a period of time on the Event Map 560 of the recipient. Pop-up menu 632 also comprises a “comment history” button 638, which may be selected for displaying all previous comments. Event Map 560 also comprises a response button 640. Response button 640 may be selected for initiating a voting procedure, which causes a vote pop-up bubble 642 to be displayed, as shown in FIG. 22. Vote pop-up bubble 642 comprises a list 644 of selectable voting options, and a vote button 646. Selecting the vote button 646 submits the option selected from list 644 as a vote. The result of the vote is displayed in a dialog box (not shown) on the general purpose computing device 12 and on participant computing devices 18.

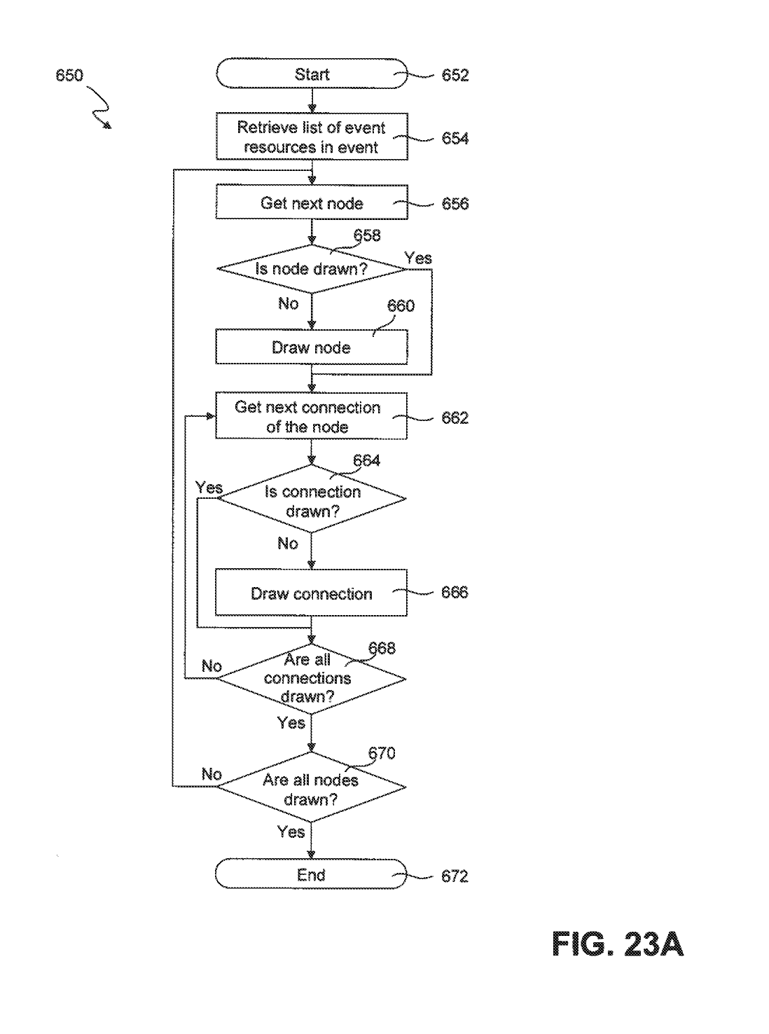

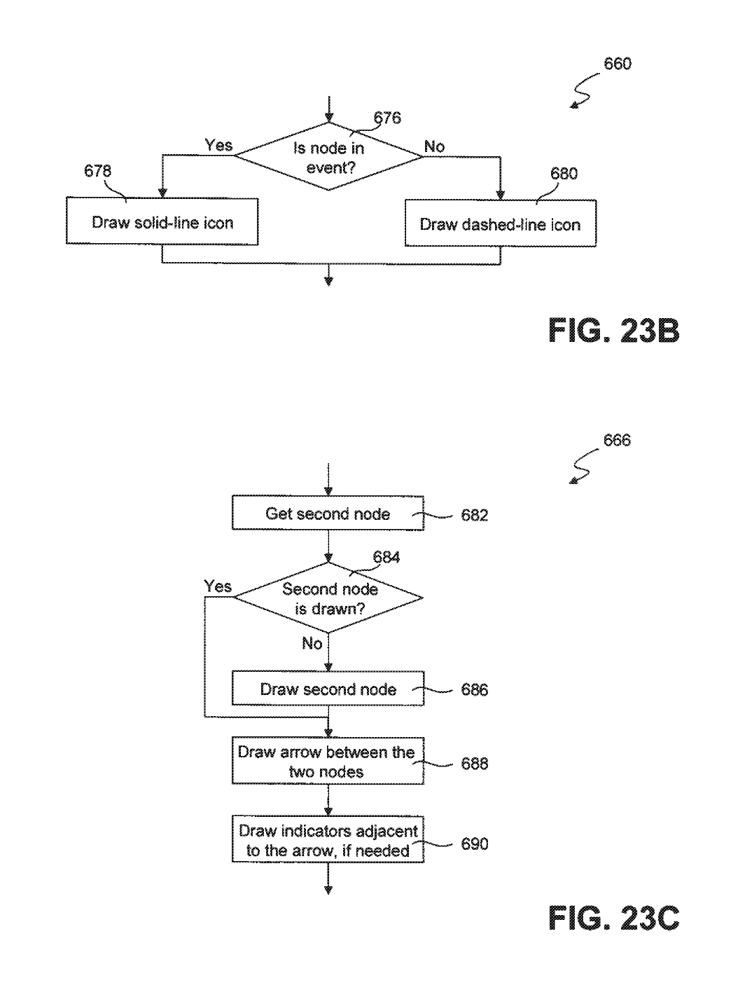

The Event Map 560 is generated by the Event Dashboard application using an Event Map generation process, which is shown in FIG. 23A and generally indicated by reference numeral 650. After process 650 starts (step 652), the Event Dashboard application retrieves a list of event resources used during the event and the relationships therebetween (step 654). As described above, the event resources are represented as nodes, and relationships therebetween are represented as arrows.

Process 650 generally begins with first node and then cycles through the remaining nodes to generate the Event Map 560. At step 656, the next node, beginning with the first node, is selected from the list of event resources. The Event Dashboard application then checks whether the node has been drawn (step 658). If the node has been drawn, the process proceeds to step 662. If the node has not been drawn, the node is drawn (step 660).

FIG. 23B shows a process used by the Event Dashboard application for drawing a node in step 660. Before drawing the node, the Event Dashboard application first checks if the node has joined the event (step 676). If the node has joined the event, the Event Dashboard application retrieves from storage a solid-line icon representing the node, and draws the icon in the Event Map 560 (step 678). If the node has not yet joined the event, the Event Dashboard application retrieves from the storage a dashed-line icon representing the node, and draws the icon in the Event Map 560 (step 680).

Turning again to FIG. 23A, following step 660, the Event Dashboard application checks all connections of each node sequentially, beginning with the first connection, and determines whether all connections have been drawn for that node. At step 662, a next connection associated with the node, beginning with the first connection, is selected. The Event Dashboard application then determines if the connection has been drawn (step 664). If the connection has been drawn, the process proceeds to step 668. If the connection has not been drawn, the connection is drawn (step 666).

FIG. 23C shows a process used by the Event Dashboard application for drawing a connection in step 666. As can be seen, the Event Dashboard application first obtains a second node associated with the connection (step 682). The Event Dashboard application then checks whether the second node has been drawn (step 684). If the second node has been drawn, the process proceeds to step 688. If the second node has not been drawn, the second node is drawn (step 686), using similar steps as those steps shown in FIG. 23B. The Event Dashboard application then draws an arrow representing the connection between the two nodes (step 688). A solid-line arrow is drawn if both nodes have joined the event, and a dashed-line arrow is drawn if any of the two nodes has not joined the event. The Event Dashboard application then checks whether indicator icons are needed to be drawn, and draws these icons if so (step 690). In this embodiment, a speaker icon is drawn if a voice bridge has been established between the two nodes, a camera icon is drawn if a video bridge has been established between the two nodes, and a computer icon is drawn if a data connection has been established between the two nodes.

Turning again to FIG. 23A, following step 666, the Event Dashboard application checks if all connections associated with the node have been drawn (step 668). If all connections have not been drawn, the process returns to step 662 to draw the next connection associated with the node. If all connections have been drawn, the Event Dashboard application then checks whether all nodes have been drawn (step 670). If all nodes have not been drawn, the process returns to step 656 to select the next node. If all nodes have been drawn, the process ends (step 672).

If a participant computing device connected to an event suffers an interruption in network connectivity, the Event Dashboard application running on that participant computing device will attempt to reconnect to the event and to re-establish any and all data, voice and video connections when the participant computing device re-establishes the network connection. The Event Dashboard application also collaborates with the client-side event recording service 102B to manage the starting, stopping and any resuming of the event recording, as well as the uploading of recorded event information.

When an event approaches its scheduled ending time, the Event Dashboard window 560 displays an “extend event?” prompt in a dialogue box. The Event Dashboard window 560 also comprises an “Extend Event” button (not shown), that may be selected for extending the event. If the “extend event?” dialogue box or the “Extend Event” button is selected, the Event Dashboard window 560 then displays the availabilities of the event room and other event resources, and also displays schedules of the event participants. The Event Dashboard window 560 also displays the booking schedules of other event rooms and resources, and displays one or more suggested times for scheduling another event at a future time. In this embodiment, the suggested times include a soonest suitable time at which the event can be held. The event host may then extend the current event using the existing event rooms and resources, if available, or schedule a continuation event in which the current event is to be continued. If the event host chooses the latter option, then the status of the current event is saved to the event server and is restored at the start of the continuation event. The schedules of the event resources, including the event participants, are updated once the event host has either extended the current event or scheduled a continuation event.

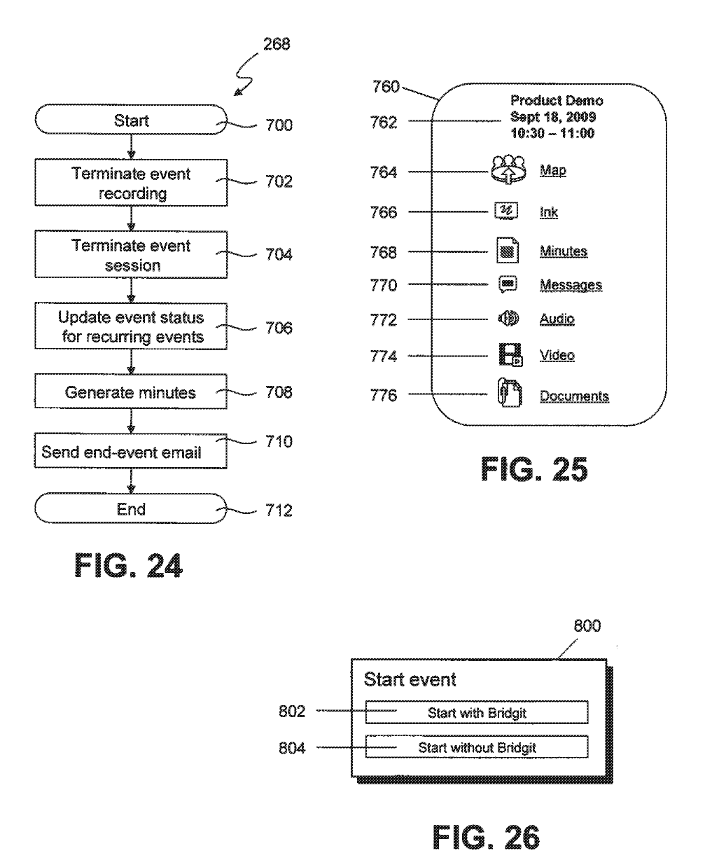

A process used for ending an event is shown in FIG. 24, and is generally indicated by reference numeral 268, corresponding to step 268 in FIG. 8. The end-event process 268 begins when an event is terminated by the event host selecting the “End Event” button 404 on the Event Dashboard window 400 (step 700), at which point event recording is terminated (step 702). The event session is then closed (step 704). Any associated data, voice and video bridges are also closed in step 704, if they have not yet been terminated. Additionally, the event room(s) and event resources therein are reset if no event is scheduled to be started in the same event room(s) within a time threshold. The resetting of the event room(s) and event room resources therein comprises, depending on system configuration, powering off the resources or placing the resources into standby mode.

If a continuation event has been scheduled, or if the event is one of a series of recurring events, then the status of the current event is used to update the recurring events or the continuation event (step 706). For example, any unchecked (i.e. uncompleted) agenda items are copied to the agenda of the continuation or recurring events, and files either attached to or opened in the event are attached to the continuation or recurring events. The event minutes are then generated (step 708). In this embodiment, the event minutes comprise the checked (i.e. completed) agenda items, any task assignments, a list of any documents opened in the event, any digital ink annotations, and the event log. An end-event email is then sent to each event participant (step 710).

In this embodiment, the end-event email sent to each participant comprises the tasks assigned to that participant, and a link to the event package created for the event. The link may be selected for displaying a home page of recorded event content, which is shown in FIG. 25 and is generally indicated by reference numeral 760. Home page 760 comprises an event description 762 showing the title, date and time of the event. Home page 760 also comprises links to recorded event content, which in the embodiment shown includes an Event Map link 764, an ink annotations link 766, an event minutes link 768, a messages link 770, an audio link 772, a video link 774, and a documents link 776. In this embodiment, selecting any of links 764 to 776 displays the selected recorded event content in the Event Dashboard window 400. Following step 710, the end-event process ends (step 712).

The methods and systems described above are not limited for use with scheduled events, but may also be for use with ad hoc events. The semantic framework 40 monitors the schedule of each event room, and maintains an updated record of its availability status. For example, if no event is currently scheduled in an event room, the event room availability status indicates the event room as being available. In this case, and provided the IWB 14 in the event room is not powered off, a “start event” dialogue box is displayed on the IWB 14, as shown in FIG. 26 and generally indicated by reference numeral 800. Dialogue box 800 comprises a button 802 which may be selected to start an ad hoc event with a Bridgit™ session, and a button 804 which may be selected to start an ad hoc event without a Bridgit™ session. After user selection of either button 802 or 804, a dialogue box (not shown) is displayed on the IWB 14 prompting the user to enter an expected duration of the ad hoc event. The user may select a default value of the ad hoc event duration, or may specify a different duration value. In this embodiment, the default ad hoc event duration is thirty (30) minutes. The duration entered by the user will be accepted provided it does not extend beyond the start time of the next scheduled event, if any. Upon acceptance of the ad hoc event duration, semantic framework 40 then updates the schedule of the event room to include the ad hoc event.

If an event has been scheduled in an event room, the semantic framework 40 updates the availability status of the event room at a time Tₐ prior to the start time of the scheduled event to indicate that the room is occupied. In this embodiment, the default value of time Tₐ is ten (10) minutes, and may be modified by any of the event host and the system administrator. At the time Tₐ prior to the start time of the scheduled event, the semantic framework 40 also begins monitoring the occupancy of the event room by analyzing the information obtained from the data acquisition layer 46. Only the participants of the scheduled event are permitted to join the event, and thereby to be recognized as occupying the event room. If no participant has occupied the event room within Tₐ minutes from the scheduled event start time, the semantic framework 40 then resets the event room, and updates the event room availability status to indicate it as being available, thereby allowing the room to be used for ad hoc events. Resetting the event room comprises, for example, disconnecting the event room general purpose computing device from the event session and respective audio, video and data streams, closing files opened on the event room computer, and resetting event room facilities. In this embodiment, the “start event” dialogue box 800 is displayed on the IWB 14 to indicate that the room is available for ad hoc events. However, the meeting session is maintained so that remote participants (if any) are still able to join the event and proceed. The schedule of the event room is not updated, and the room still appears as occupied. Therefore, in the scenario that participants of the originally scheduled event come to the event room, they may negotiate with the participants of the current ad hoc event to decide which party should occupy the event room. The party to leave the event room may then cancel the event (i.e., the original event or the ad hoc event), or move the event to an available event room. At the scheduled end time of the original event, if no participant is in the event, the event session is automatically terminated.

After an ad hoc event starts, the event management process, the event recording process and the end-event processes described above are used to manage and record the ad hoc event. In this embodiment, the Event Dashboard application is used to manage the participants and resources of the ad hoc event, to attach files and projects to the event, to display an Event Map and to record the event to an event package.

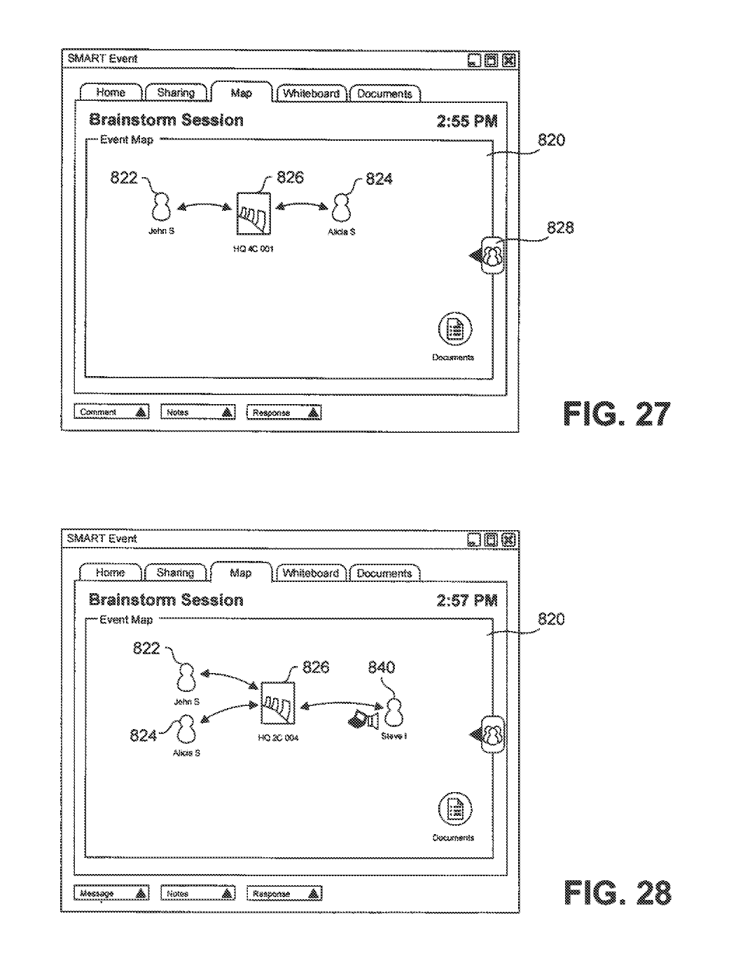

FIG. 27 shows an Event Map 820 of an ad hoc event started by two participants 822 and 824 in an event room 826. Here, the event room 826 is a meeting room. No data, voice or video bridges are set up for the event, and thus no audio, video or data server is shown in Event Map 820. The participants may invite other persons to join the event by using the participant list button 828. An event invitation is sent to each person added to the participant list, as described above with reference to FIGS. 17 to 22. A recipient of an event invitation may accept the invitation and thereby join the ad hoc event. FIG. 28 shows the Event Map 820 updated after a participant 840 has joined the ad hoc event from a remote site using a participant computing device 18. As there is now a remote participant in the ad hoc event, a data connection is automatically established between the general purpose computing device 12 in event room 826 and the participant computing device 18 of the remote participant 840. In this embodiment, the general purpose computing device 12 also automatically instructs the phone in the event room 826 to dial the remote participant's phone number to establish a voice connection between the event room 826 and the remote participant 840. The remote participant 840 may also select the icon of the event room 826, thereby dialing a phone therein. In the embodiment shown, no voice or data server is used in the event room 826 since there is only one data and one voice connection, respectively.

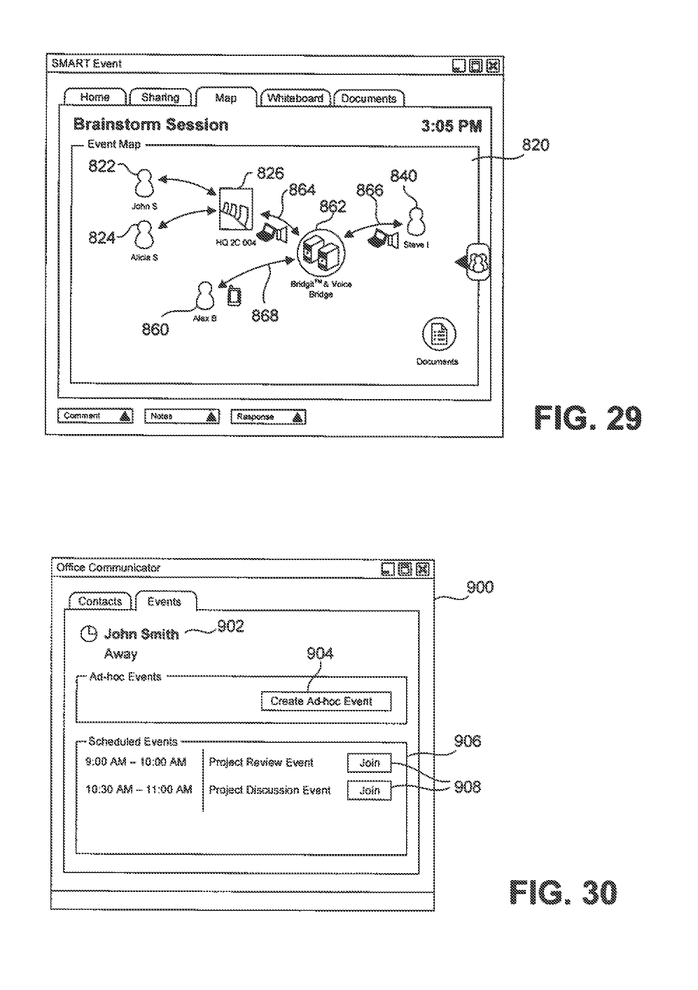

FIG. 29 shows the Event Map 820 updated after another remote participant 860 has joined the ad hoc event using a mobile device. According to predefined rules of the embodiment shown, when more than one data, voice or video connection between event participants is required, corresponding data, voice and video bridges are created in a Bridgit™ and a voice bridge 862, and connections between the event room 826 and the remote participants 840 and 860 are switched thereto, as indicated by connection arrows 864, 866 and 868.

Although in embodiments described above the Event Dashboard application is described as a separate entity running on a computing device, in other embodiments, part of the Event Dashboard application may alternatively be implemented as a plugin of one or more other application programs, such as for example email programs, calendar programs, and instant messaging application programs, such as for example Microsoft Outlook® or Microsoft Office Communicator. For example, FIG. 30 shows an example of an event Dashboard plugin window 900 for Microsoft Office Communicator. Event Dashboard plugin window 900 comprises an indicator 902 showing the user's name and status, and also comprises a button 904 that may be selected for creating an ad hoc event. Event Dashboard plugin window 900 also comprises a list 906 of scheduled events, with each of the events having an associated button 908 that may be selected for joining the event.

Although in embodiments described above, event content is automatically recorded from the start of an event to the end of the event, in other embodiments, the Event Dashboard window may alternatively comprise an event record start/stop button that is selectable for starting and stopping recording of event content.

Although in embodiments described above, a user may join an event by selecting either of two message bubbles, in other embodiments, the user may alternatively be automatically joined to the event upon successful facial recognition. In these embodiments, the other identity messages received by the event manager comprise face recognition identity messages collected by the data acquisition layer. Images captured by the cameras associated with the general purpose computing device 12 and with each of the participant computing devices 18, together with images captured by the video camera in the event room, are processed by the semantic framework layer using facial recognition analysis for generating face recognition identity messages upon authentication of participants. Alternatively, the other identity images received by the event manager may be images captured by the cameras, and processed by the event manager using facial recognition analysis. Upon successful facial recognition analysis, the event manager joins the user to the event. If no face recognition identity message is received by the event manager, the user is prompted to manually log in to the event by scanning an RFID card in the event room. If the RFID card is recognized and the user is a participant of the event, the user then joins the event. However, if the RFID card is not recognized or if the user is not a participant of the event, a dialogue box is displayed on the IWB 14 prompting the user to input a username/password combination. A comment is also automatically sent to the event host indicating that a user's identity recognition and the RFID card recognition have failed, and that the user is manually logging into the event.

Those of skill in the art will appreciate that in other embodiments, a workspace may be created in the event server when an event is scheduled. Files attached to the event may then be uploaded into the event workspace. In a related embodiment, files of projects associated to an event may alternatively be automatically located and uploaded to the event workspace.

The methods described above for managing an event in an organization environment may be embodied in one or more software applications comprising computer executable instructions executed by computer servers, desktop computers, laptop computers, notebook computers, tablet computers, PDAs, smartphones and/or other suitable information computing devices. The software applications may comprise program modules including routines, programs, object components, data structures, and the like, and may be embodied as computer readable program code stored on a non-transitory computer readable medium. The computer readable medium is any data storage device that can store data. Examples of computer readable media include for example read-only memory, random-access memory, CD-ROMs, magnetic tape, USB keys, flash drives and optical data storage devices. The computer readable program code can also be distributed over a network including coupled computer systems so that the computer readable program code is stored and executed in a distributed fashion.

Although in the embodiments described above the event management application is integrated with a Microsoft® Outlook®/Exchange Server®, those of ordinary skill in the art will understand that the application may alternatively be integrated with other email servers, or may alternatively be integrated with a semantics-based email server.

Although in the embodiments described above, emails and instant messaging are used to notify event participants, event rooms and resources of upcoming events, in other embodiments, other communication forms such as for example, text messaging and voice mail, may alternatively be used.

Although in the embodiments described above, the Event Scheduler application is used for scheduling an event, in other embodiments, other event scheduling applications such as Microsoft® Exchange may alternatively be used for scheduling events, and may alternatively be integrated in the system in substitution for the Event Scheduler.

Although in embodiments described above, separate computer servers are used for managing events, bridging audio, video and data streams and serving databases for providing information regarding event-related resources, such as for example employee information and project information, in other embodiments, the servers may be instances created by server software that are all run on the same computer server. In still other embodiments, a given server function may alternatively be distributed among and provided by multiple computer servers.

Although in embodiments described above an interactive whiteboard is connected to the general purpose computing device in the event room and serves as a display device and as an interactive input device, in other embodiments, other interactive input devices may be used, such as, for example touch-enabled computer monitors, computer mice, keyboards, slates, trackballs, gamesticks, and the like. In a related embodiment, a conventional computer monitor may be connected to the general purpose computing device.

Although in embodiments described above various functions are executed by the general purpose computing device, in other embodiments, these various functions may alternatively be executed by a participant computing device, or by a personal computer, a laptop or notebook computer, a tablet computer, a PDA, a smartphone, any other suitable computing device.

Although in embodiments described above, semantics based approaches are used to collect information of event resources, to manage their schedules, and to manage events based on the collected information, in other embodiments, other approaches may alternatively be used.

Although in embodiments described above the semantics-based applications are standalone applications, in other embodiments, the semantics-based applications may be plugins to other applications such as for example Microsoft® Outlook®. In other embodiments, non-semantic-based applications, such as SMART Meeting Pro and SMART Meeting Pro Premium, may also be integrated into the system.

Those skilled in the art will appreciate that, in some alternative embodiments, the general purpose computing device may also serve as an event server. In still other embodiments, the general purpose computing device may also serve as an audio, video and data server providing audio, video and data streams to all participants in an event.

Those skilled in the art will appreciate that, in some alternative embodiments, the system may comprise any number of servers, general purpose computing devices, and IWBs. As will be understood, systems of these alternative embodiments may enable people in different event sites to join an event and to collaborate with each other.

Although in embodiments described above, a plurality of semantics-based applications communicate with the semantic framework layer 40 via a software interface/software development kit (SDK) 44 to perform various functions, in other embodiments, the SDK 44 is implemented as an agent development kit to provide more flexibility in the design of semantics-based applications.

Although in embodiments described above, the notification receiver is configured to receive notification from the event server and to display information therein in the form of an information pop-up bubble or a window, in other embodiments, notifications may be sent to clients, such as event participants, event rooms and event facilities, in the form of an instant message or an email.

Although in embodiments described above, the event manager sends notification to a user when it is detected that the user is currently in a first event and a second event that the user is scheduled to attend has started, where the notification is in the form of a pop-up bubble, in other embodiments, the user may be automatically logged out of the first event and logged into the second event. In other embodiments, the user is automatically logged into any event clicked by the user in the pop-up bubble so that the user may attend multiple events at the same time.

Although in embodiments described above, the server-side event recording service is provided by one or more computer servers in the intranet of an organization or a network cloud, in other embodiments, the server-side event recording service may alternatively be designed as a set of web services accessible via HTTP/SOAP (Hypertext Transfer Protocol/Simple Object Access Protocol).

Although in embodiments described above, a user is automatically logged-in to an event when the user's RFID is detected upon entering an event room, in other embodiments, the user may alternatively manually log in to the event by entering a user name and password.

Although in embodiments described above, the Event Dashboard application is installed and runs on client-side devices, in other embodiments, a web based or Rich Internet Application (RIA) Event Dashboard may be provided to users who do not have the Event Dashboard application installed.

Although in embodiments described above, a user establishes a voice connection to the event by selecting the voice conferencing server icon, after which the voice conferencing server calls that user's phone number registered in the system, in other embodiments, the system may alternatively send a message comprising the voice conferencing server's phone number and password to the user's telephone, and with instructions to call the voice conferencing server, so as to thereby establish the voice connection to the event.

Although in embodiments described above, the audio, video and data streams are processed by two servers, namely a SMART Bridgit™ server for processing video and data streams and a Cisco MeetingPlace server for processing audio streams, in other embodiments, the audio, video and data streams may alternatively be processed by any number of servers. In a related embodiment, the audio, video and data streams may alternatively be processed by a single SMART Bridgit™ server. In another embodiment, the Meeting Map window may alternatively display icons for indicating the type of stream, namely audio, video or data, currently being processed by the Bridgit™ server. In another embodiment, the audio, video and data streams may alternatively be processed by multiple SMART Bridgit™ servers forming a server network.

Although in embodiments described above the event manager applies additional rules to input messages, and where the additional rules are defined and modified by an event host, in other embodiments, the additional rules may alternatively be any of activated, deactivated, added, edited and deleted by the event host. In still other embodiments, the additional rules may alternatively be any of activated, deactivated, added, edited and deleted by any authorized user, such as for example a system administrator, or may be predefined.

Although in embodiments described above, the client-side event recording service is provided by the general purpose computing device, in other embodiments, the client-side event recording service may alternatively be provided by one or more participant computing devices.

Although in embodiments described above, the server-side and client-side event recording services allow only certain types of content of the event to be recorded, where the certain types of content are user-defined, in other embodiments, the certain types of content may alternatively be defined by equipment resource availability.

Although in embodiments described above, an event management process comprises a step in which information collected from the data acquisition layer is processed by the event manager, it will be understood that, in the case of an ad hoc event, relevant information may alternatively be provided in the event rooms by users for facilitating the set up of the ad hoc event.

Although in embodiments described above, the project database is an external database stored on a server, in other embodiments, the project database may alternatively form part of the semantic framework layer.

Although in embodiments described above, the Event Dashboard application automatically terminates the user from a current event before the user is able to join another selected event, in other embodiments, the Event Dashboard application joins the user to the selected event without terminating the user from the current event, thereby allowing the user to attend multiple events simultaneously.

Although in embodiments described above, files associated with projects are stored in the project database, in other embodiments, files associated with projects may alternatively be stored in a file server, with their location information stored in the project database, depending on the configuration of the project database.

Although in embodiments described above, the selection of a link to selected recorded event content displays the selected recorded event content in the Event Dashboard window, in other embodiments, selecting the link may alternatively display the selected recorded event content in a window specific to the selected content. For example, selecting a link of an Event Map may alternatively open the Event Map in a map viewing window, selecting a link of event minutes may alternatively open the event minutes in a browser window, and selecting on the link of event video may alternatively open the event minutes in a video player window.

Although in embodiments described above, the Event Dashboard application is used to manage the participants and resources of an ad hoc event, to attach files and projects to the ad hoc event, to display an Event Map and to record the ad hoc event to an event package, in other embodiments, the ad hoc event may be managed by other applications, such as for example Bridgit (and optionally plus voice bridge), or Meeting Pro/Meeting Pro Premium.

Although in embodiments described above, the Event Map is generated by the Event Dashboard application, in other embodiments, an external application for generating the Event Map may alternatively be implemented through Bridgit, Meeting Pro/Meeting Pro Premium or any other event management application, and without using the Event Dashboard application.

Although in embodiments described above, the system comprises two (2) sensors in the event room configured for detecting the presence of participants within the event room, in other embodiments the system may alternatively comprise no sensors within the event room, one (1) sensor or more than two (2) sensors within the event room. In still other embodiments, the system may alternatively comprise one or more sensors in each of a plurality of event rooms.

Although in embodiments described above, the system comprises sensors in the event room, wherein the sensors are a radio frequency identification (RFID) sensor and a video camera, in other embodiments, the sensors may alternatively be any type of sensor capable of detecting the presence of participants, such as for example, an infrared sensor, or any other form of sensor.

Although in embodiments described above, the event services comprise an event notification service, an event recording service, an Event Map service, and an event control service, in other embodiments, the event services may alternatively comprise other event-related services.

Although in embodiments described above, comments sent between participants the using comment board and the Comment board window are text comments and thereby comprise only text, in other embodiments, the comments may alternatively also comprise one or more recorded audio streams linked to the comment using comment board 432 and Comment board window 520. In a related embodiment, where a comment comprises a recorded audio stream, upon sending the comment, the recorded audio stream may alternatively be processed using voice-to-text recognition so as to generate text, and the generated text added to the comment comprising the audio stream.

Although in embodiments described above, the client-side event recording service is started and terminated by the client-side event management application running on the general purpose computing device, where the client-side event application is the Event Dashboard, in other embodiments, the client-side event application may alternatively be the SMART Meeting Pro, SMART Meeting Pro Premium, or any other any event application running on SMART HUB.

Although the embodiments described above refer to systems and methods relating to an event within an organization, where the event is a meeting and the organization is a business entity such as a corporation, it will be understood that the systems and methods may relate to other events and other organizations. For example, the organization may be a gym and the event may be a fitness class within the gym, wherein the fitness class uses fitness equipment. As another example, the systems and methods may be used by educational institutes for managing libraries, for arranging course schedules using optimized resources, such as classrooms, lecture halls, labs and teaching facilities, and for more efficiently arranging teacher and student schedules.

Although in embodiments described above the other identity messages are face recognition identity messages, in other embodiments, the other identity messages may be any of face recognition identity messages and biometrics identity messages.

Although in embodiments described above, the system comprises a sensor in the event room that is a video camera, and the general purpose computing device and one or more of the participant computing devices are equipped with a respective camera, in other embodiments, any camera configuration may alternatively be used. For example, in other embodiments, a camera may be installed on the IWB. In still other embodiments, the system may alternatively comprise no cameras.

Although in embodiments described above, the cameras automatically capture images of the user during use, in other embodiments, the cameras may alternatively capture images of the user upon user command.

Although in embodiments described above, the semantic framework updates the event room availability status by analyzing the information obtained from the data acquisition layer to determine event room occupancy, in other embodiments, the semantic framework may update the event room availability status based on whether or not a participant has joined the event.

Although embodiments have been described, those of skill in the art will appreciate that variations and modifications may be made without departing from the scope thereof as defined by the appended claims.

What is claimed is:

1. A method for coordinating resources for events, the method comprising:
identifying participants for an event;
collecting information concerning the identified participants, the information at least comprising availability schedules; and
providing an event monitoring interface to at least one participant device, the event monitoring interface presenting a representation of identified participants and at least one resource associated with the event.

2. A method according to claim 1, further comprising:
determining resources to be used for the event according to locations of the participants.

3. A method according to claim 2, further comprising:
setting up at least one of a video bridge, an audio bridge, and a data bridge between at least one participant device and a server.

4. A method according to claim 1, wherein the representation visually distinguishes participants that have joined the event from participants that have not joined the event.

5. A method according to claim 2, wherein the representation visually distinguishes resources that have joined the event from resources that have not joined the event.

6. A method according to claim 1, further comprising:
scheduling the event based on the collected information; and
starting the event according to the scheduling.

7. A method according to claim 6, wherein the collecting comprises collecting the information from any of an employee database, an e-mail server, a projects server, a file server, a sensor, and a camera.

8. A method according to claim 6, further comprising extracting additional information from the information collected from unstructured sources.

9. A method according to claim 6, further comprising recording event content in an event log.

10. A method according to claim 9, wherein the event content comprises any of audio data, video data, event notes, event minutes, and documents.

11. A method according to claim 6, wherein the event monitoring interface is provided to each participant device after said starting step, and after the at least one participant has logged in to the event.

12. A method according to claim 11, wherein the at least one participant is logged in to the event automatically using face recognition identity information.

13. A method according to claim 11, wherein the event monitoring interface displays at least one connection between the resources.

14. A method according to claim 6, further comprising attaching any of a document and a project to the event.

15. A method according to claim 6, further comprising:
terminating the event; and
generating event minutes.

16. A method according to claim 1, further comprising:
starting the event in response to an ad hoc event request.

17. A method according to claim 16, wherein the collecting comprises collecting the information from any of an employee database, an e-mail server, a projects server, a file server, a sensor, and a camera.

18. A method according to claim 16, further comprising extracting additional information from the information collected from unstructured sources.

19. A method according to claim 16, further comprising recording event content in an event log.

20. A method according to claim 19, wherein the event content comprises any of audio data, video data, event presentation, event minutes, and documents.

21. A method according to claim 16, further comprising inviting at least one other participant to join the event.

22. A method according to claim 16, wherein providing the event monitoring interface further comprises providing a meeting map.

23. A method according to claim 22, wherein the meeting map displays at least one connection between the resources.

24. A method according to claim 16, the method further comprising:
terminating the event; and
generating event minutes.

25. A system for coordinating resources for events, the system comprising:
a network; and
processing structure in communication with the network, the processing structure being configured to:
select participants for an event;
collect information concerning the selected participants, the information comprising availability schedules; and
provide an event monitoring interface to at least one participant device, the event monitoring interface presenting a representation of identified participants and at least one resource associated with the event.

26. A system according to claim 25, wherein the processing structure is further configured to:
determine resources to be used for the event according to locations of the participants.

27. A system according to claim 26, wherein the processing structure is further configured to:
set up at least one of a video bridge, an audio bridge, and a data bridge between at least one of the participants and a server.

28. A system according to claim 25, wherein the representation visually distinguishes participants that have joined the event from participants that have not joined the event.

29. A system according to claim 26, wherein the representation visually distinguishes resources that have joined the event from resources that have not joined the event.

30. A system according to claim 25, wherein the processing structure is further configured to:
schedule the event based on the collected information; and
start the event according to the scheduling.

31. A system according to claim 30, further comprising the at least one participant device.

32. A system according to claim 30, further comprising any of an e-mail server, a projects server, and a file server, the servers being in communication with the network.

33. A system according to claim 30, further comprising at least one sensor in communication with the network.

34. A system according to claim 30, further comprising at least one of a video server, an audio server, and a data server in communication with the network.

35. A system according to claim 25, wherein the processing structure is further configured to:
start the event in response to an ad hoc event request.

36. A system according to claim 35, further comprising the at least one participant device.

37. A system according to claim 35, further comprising any of an e-mail server, a projects server, and a file server, the servers being in communication with the network.

38. A system according to claim 35, further comprising at least one sensor in communication with the network.

39. A system according to claim 35, further comprising at least one of a video server, an audio server, and a data server in communication with the network.

40. A method comprising:
initiating an event by identifying participants;
directing collection of information relating to the identified participants; and
directing the presentation of an event monitoring interface for providing a representation of participants and at least one resource associated with the event.

41. A method according to claim 40, further comprising:
determining resources to be used for the event according to locations of the participants.

42. A method according to claim 40, wherein the representation visually distinguishes participants that have joined the event from participants that have not joined the event.

43. A method according to claim 40, further comprising:
scheduling the event based on the collected information; and
starting the event according to the scheduling.

44. A method according to claim 43, further comprising recording event content in an event log.

45. A method according to claim 40, further comprising:
starting the event in response to an ad hoc event request.

46. A method comprising:
receiving a request to join an event; and
upon joining the event in response to said request, receiving instructions for displaying an event monitoring interface, the event monitoring interface providing a representation of participants and at least one resource associated with the event.

47. A method according to claim 46, wherein the representation visually distinguishes participants that have joined the event from participants that have not joined the event.

48. A server configured to coordinate resources for events, the server being configured to:
identify participants for an event;
collect information concerning the identified participants, the information at least comprising availability schedules; and
cause a representation of identified participants and at least one resource associated with the event to be presented by at least one participant device.

49. A server according to claim 48, wherein the server is further configured to:
determine resources to be used for the event according to locations of the participants.

50. A server according to claim 49, wherein the server is further configured to:
cause at least one of a video bridge, an audio bridge, and a data bridge to at least one participant device to be set up.

51. A server according to claim 48, wherein the representation visually distinguishes participants that have joined the event from participants that have not joined the event.

52. A server according to claim 48, wherein the server is further configured to:
schedule the event based on the collected information; and
cause the event to be started according to the scheduling.

53. A server according to claim 52, wherein the server is further configured to record event content in an event log.

54. An apparatus comprising:
processing structure; and
memory in communication with the processing structure, the memory having embodied thereon computer-readable code which, when executed by the processing structure, directs the apparatus to:
establish communication with a remotely hosted event during which information concerning identified event participants is collected, the information at least comprising availability schedules; and
display an event monitoring interface, the event monitoring interface presenting a representation of identified participants and at least one resource associated with the event.

55. An apparatus according to claim 54, wherein the computer-readable code further directs the apparatus to:
determine resources to be used for the event according to locations of the participants.

56. An apparatus according to claim 55, wherein the representation visually distinguishes participants that have joined the event from participants that have not joined the event.

57. An apparatus according to 54, wherein the computer-readable code further directs the apparatus to display the event monitoring interface after the event has started.

58. An apparatus according to claim 57, wherein the event monitoring interface displays at least one connection between resources of the event.

59. A non-transitory computer-readable medium having embodied thereon a computer program for coordinate resources for events, the computer program comprising computer-readable code which, when executed by processing structure, carry out:
identifying participants for an event;
collecting information concerning the identified participants, the information at least comprising availability schedules; and
providing an event monitoring interface to at least one participant device, the event monitoring interface presenting a representation of identified participants and at least one resource associated with the event.

60. A non-transitory computer-readable medium according to claim 59, further comprising computer-readable code which, when executed by the processing structure, carry out:
determining resources to be used for the event according to locations of the participants.

61. A non-transitory computer-readable medium according to claim 60, further comprising computer-readable code which, when executed by the processing structure, carry out:
initiating set up of at least one of a video bridge, an audio bridge, and a data bridge to at least one participant device.

62. A non-transitory computer-readable medium according to claim 59, wherein the representation visually distinguishes participants that have joined the event from participants that have not joined the event.

63. A non-transitory computer-readable medium according to claim 59, further comprising computer-readable code which, when executed by the processing structure, carry out:
scheduling the event based on the collected information; and
starting the event according to the scheduling.

64. A non-transitory computer-readable medium according to claim 63, further comprising computer-readable code which, when executed by the processing structure, carry out:
recording event content in an event log.

65. A non-transitory computer-readable medium according to claim 63, further comprising computer-readable code which, when executed by the processing structure, carry out:
terminating the event; and
generating event minutes.

66. A non-transitory computer-readable medium according to claim 59, further comprising computer-readable code which, when executed by the processing structure, carry out:
starting the event in response to an ad hoc event request.
